(19) United States
(12) Patent Application Publication
(10) Pub. No.: US 2006/0233998 A1
(43) Pub. Date: Oct. 19, 2006

(54) Optical recording medium, method for manufacturing the same, sputtering target, method for using optical recording medium, and optical recording apparatus

(76) Inventors: Mikiko Takada, Yokohama-shi (JP); Kazunori Ito, Yokohama-shi (JP); Hiroshi Deguchi, Yokohama-shi (JP); Hiroko Ohkura, Yokohama-shi (JP); Masaki Kato, Sagamihara-shi (JP)

Correspondence Address: COOPER & DUNHAM, LLP, 1185 AVENUE OF THE AMERICAS, NEW YORK, NY, 10036, US

(21) Appl. No.: 11/429,140

(22) Filed: May 4, 2006

Related U.S. Application Data
(63) Continuation of application No. PCT/JP04/16635, filed on Nov. 10, 2004.

(30) Foreign Application Priority Data
Nov. 10, 2003 (JP) 2003-379378
Mar. 1, 2004 (JP) 2004-056170

(51) Int. Cl. B32B 3/02

(52) U.S. Cl. 428/64.1

(57) ABSTRACT

To provide an optical recording medium which can maintain excellent recording characteristics and storage reliability even at high recording speeds of 3× to 10× on DVD, particularly at 8× or faster, and whose recording material can be readily initialized to provide a uniform reflectivity distribution. The optical recording medium includes a substrate, first protective layer, recording layer, second protective layer and reflective layer, the first protective layer, recording layer, second protective layer and reflective layer being disposed on the substrate in this order or in reverse order, wherein the recording layer comprises a composition expressed by the Formula (X₁)_{α}Sb_{β}(X₂)_{γ} where X₁ represents at least one element selected from Ga, Ge and In; X₂ represents at least one element selected from Au, Ag and Cu; and α, β and γ represent atomic % of their respective elements (where 2≦α≦20, 55≦β≦95, 0<γ≦10, and (α+β+γ)=100).

### CROSS-REFERENCE TO RELATED APPLICATIONS

This is a continuation of Application PCT/JP2004/016635, filed on Nov. 10, 2004.

### BACKGROUND OF THE INVENTION

1. Field of the Invention

The present invention relates to an optical recording medium (hereinafter sometimes referred to as a “phase-change optical information recording medium”, “phase-change optical recording medium”, or “optical information recording medium”) which can maintain excellent recording characteristics and storage reliability even at high recording speeds of 3× to 10× on DVD, particularly at 8× or faster, and whose recording material can be readily initialized to provide a uniform reflectivity distribution; a method for manufacturing the same; a sputtering target; a method for using the optical recording medium; and an optical recording apparatus.

2. Description of the Related Art

So-called phase-change optical recording media that utilize a transition between crystalline and amorphous phases have been known as one of rewritable optical recording media where information is erasable by irradiation with a semiconductor laser beam. The phase-change optical recording media realize repetitive recording with a single beam irradiation and require a simple optical system on the drive side. For these reasons, they are now widely used as optical recording media in many fields including computers, pictures, and audio. Optical recording media (e.g., CD-R, CD-RW and DVD) recording speed has been increased along with extensive worldwide distribution. It is now demanded that optical recording media have increased storage capacity and density enough to support, for example, high-density image recording. Against this backdrop, attempts have been made to achieve recording at higher speeds.

The optical information recording medium is generally constituted of a substrate and a recording layer provided on the substrate, and generally, a translucent protective layer with heat resistance is provided on both sides of the recording layer. In addition, a reflective layer is provided on the opposite side of the protective layer from the side where a light beam is incident. In the optical information recording medium, information can be recorded or erased only by changing laser beam power; crystallized portions of the recording layer serve both as non-recorded areas and information-erased area, and amorphous portions serve as recording marks (amorphous marks).

In the optical recording medium a focused, pulsed laser beam of three different output levels is used to switch the recording layer back and force between crystalline and amorphous phases. At this point, the pulse of maximum output level serves to melt the recording layer, the pulse of intermediate output level serves to heat the recording layer to temperatures higher than its crystallization temperature but just below its melting point, and the pulse of minimum output level serves to control the heating or cooling of the recording layer. The recording layer that has melted as a result of irradiation with a laser pulse of maximum output level then undergoes rapid cooling down, changing to an amorphous or microcrystal state to cause a reduction in the reflectivity. In this way the amorphous or microcrystal portion of the recording layer function as a recording mark. Meanwhile, a portion of the recording layer irradiated with a laser pulse of intermediate output level completely becomes crystalline, whereby information can be erased. In this way alternating crystalline areas and amorphous areas can be formed on the recording layer by changing the writing laser pulse output levels, recording information on the recording layer.

In order to achieve high-speed recording in the optical recording medium, its recording layer requires phase-change materials that rapidly crystallizes. For such phase-change materials, Sb—Te phase-change materials doped with Ga, Ge, In and the like have been used (see Japanese Patent Application Laid-Open (JP-A) No. 60-179954, 05-286249, 07-065414, 07-120867, 08-212604, 2000-190637, 2000-339750, 2001-067722, 2002-264514, 2002-283726, 2002-331758 and 2003-006859; Japanese Patent Application Publication (JP-B) No. 03-052651, 04-001933; Japanese Patent (JP-B) No. 2941848 and 3214210; and “Phase-Change optical data storage in GaSb”, Applied Opticas, Vol. 26, No. 22115, November, 1987). This is because chalcogen elements (S, Se and Te) feature the ability to bind to many elements to create many different amorphous phases. For this reason, chalcogen elements, especially Te, have been received attention as essential constituents of phase-change materials.

For high-speed recording, acceleration of the crystallization rate of a recording layer is not enough; it is also necessary to ensure the stability of amorphous portions (marks). Although the use of recording materials with high crystallization rate leads to poor stability in amorphous portions, the use of recording materials with high crystallization rate but with high crystallization temperature can ensure the stability of formed marks for a long period of time. For example, there is a report that Ga—Sb phase-change materials, known as recording materials for high-speed recording, have significantly high crystallization rate and crystallization temperature, which is as high as 350° C. (see “Phase-Change optical data storage in GaSb”, Applied Opticas, Vol. 26, No. 22115, November, 1987). The use of such recording materials realizes the provision of an optical recording medium which is capable of recording at 8×DVD recording speed or faster, as well as excellent in mark stability. These recording materials, however, have a severe drawback: “poor initialization performance”. Such recording materials cannot be readily initialized because of their high crystallization temperature. Even when they are initialized by applying a high-energy beam, there are fluctuations in the reflectivity from one portion to another on the initialized region of the disc, adversely affecting its recording characteristics.

Accordingly, there has yet been no optical recording medium which can maintain excellent recording characteristics and storage reliability even at high recording speeds of 3× to 10× on DVD, particularly at 8× or faster, and whose recording material can be readily initialized to provide a uniform reflectivity distribution. It is demanded that such an optical recording medium be provided as soon as possible.

### SUMMARY OF THE INVENTION

It is an object of the present invention to solve the conventional problems and, in response to the demand as described above, to provide an optical recording medium which can maintain excellent recording characteristics and storage reliability even at high recording speeds of 3× to 10× on DVD, particularly at 8× or faster, and whose recording material can be readily initialized to provide a uniform reflectivity distribution; a method for manufacturing the same; a sputtering target; a method for using an optical recording medium; and an optical recording apparatus.

The present inventors have focused attention on Ga—Sb materials that are potentially suitable for high-speed recording during the development of optical recording media that can support high-speed recording as fast as 3× to 10×DVD recording speeds, particularly as fast as 8× or faster, and have diligently conducted studies. As a result, they have established that it is possible to solve the problems associated with initialization of the recording layer by uniformly dispersing crystalline particles made of at least one element selected from Au, Ag and Cu in the Ga—Sb material of the recording layer. They have also established that by adding Sn and the like in the Ga—Sb material it is possible to provide an optical recording medium which can ensure excellent recording characteristics and storage reliability even at high recording speeds of 8× or faster on DVD.

The present invention has been accomplished based on the findings by the present inventors. The followings are means for solving the foregoing problems.

<1> An optical recording medium having a substrate, a first protective layer, a recording layer, a second protective layer, a reflective layer, the first protective layer, recording layer, second protective layer and reflective layer being disposed on the substrate in this order or in reverse order, wherein the recording layer comprises a composition expressed by the following Formula 1:
(X₁)_{α}Sb_{β}(X₂)_{γ} <Formula 1>

where X₁ represents at least one element selected from Ga, Ge and In; X₂ represents at least one element selected from Au, Ag and Cu; and α, β and γ represent atomic % of their respective elements (where 2≦α≦20, 55≦β≦95, 0<γ≦10, and (α+β+γ)=100).

The optical recording medium according to the first embodiment of the present invention comprises the foregoing composition. Thus, it is possible to provide an optical recording medium which can realize excellent recording characteristics and storage reliability even at high recording speed of 8× on DVD (about 28 m/s) and whose recording material can be readily initialized to provide a uniform reflectivity distribution.

<2> An optical recording medium having a substrate, a first protective layer, a recording layer, a second protective layer, and a reflective layer, the first protective layer, recording layer, second protective layer and reflective layer being disposed on the substrate in this order or in reverse order, wherein the recording layer comprises a composition expressed by the following Formula 2:
(X₁)_{α}Sb_{β}(X₂)_{γ}-M_{δ} <Formula 2>

where X₁ represents at least one element selected from Ga, Ge and In; X₂ represents at least one element selected from Au, Ag and Cu; M represents at least one element selected from elements other than X₁, Sb and X₂ and mixtures of the elements other than X₁, Sb and X₂; and α, β, γ and δ represent atomic % of their respective elements (where 2≦α≦20, 55≦β≦95, 0<γ≦10, 0<δ≦40, and (α+β+γ+δ)=100).

The optical recording medium according to the second embodiment of the present invention comprises the foregoing composition. Thus, it is possible to provide an optical recording medium which can realize excellent recording characteristics and storage reliability even at high recording speeds of 3× to 10× on DVD, particularly at 8× or faster, and whose recording material can be readily initialized to provide a uniform reflectivity distribution.

<3> The optical recording medium according to <2>, wherein M represents at least one element selected from Te, Al, Zn, Mg, Tl, Pb, Sn, Bi, Cd, Hg, Se, C, N, Mn and Dy. In the optical recording medium according to <3>, any of Te, Al, Zn, Mg, Tl, Pb, Sn, Bi, Cd, Hg, Se, C, N, Mn and Dy has an effect of increasing the crystallization rate, whereby high-speed recording is made possible. These elements, however, are less potent in increasing the crystallization rate while keeping excellent recording characteristics than Ga and In. The total amount of these elements is preferably 20 atomic % or less. In addition, Te, Al, Zn, Se, C and N also have an effect of improving storage reliability, though they are less potent than Ge.

<4> The optical recording medium according to one of <2> and <3>, wherein the recording layer comprises a composition expressed by the following Formula 3. The optical recording medium according to <4> comprises Sn as an essential constituent. Sn not only has an effect of increasing the crystallization rate as do Ga and In, but also is advantageous over Ga and In in terms of the capability of lowering the melting point of recording material, improving the sensitivity of recording media, increasing reflectivity, and reducing initialization noises. Thus, Sn is an excellent additive element that can increase recording characteristics in a comprehensive manner. If the content of Sn is greater than 40 atomic %, it results in too high crystallization rate, making it difficult for the recording layer to be amorphized.
(X₁)_{α}Sb_{β}(X₂)_{γ}—Sn_{δ} <Formula 3>

where X₁ represents at least one element selected from Ga, Ge and In; X₂ represents at least one element selected from Au, Ag and Cu; and α, β, γ and δ represent atomic % of their respective elements (where 2≦α≦20, 55≦β≦95, 0<γ≦10, 0<δ≦40, and (α+β+γ+δ)=100).

<5> The optical recording medium according to any one of <1> to <5>, wherein the recording layer is expressed by the formula Ga_{α}Ge_{β}In_{γ}—Sb_{δ}—(X₂)_{ε}Sn_{ζ}—Y_{η} where X₂ represents at least one element selected from Au, Ag and Cu; Y represents at least one element selected from Te, Al, Zn, Mg, Tl, Pb, Bi, Cd, Hg, Se, C, N, Mn and Dy; and α, β, γ, δ, ε, ζ and η satisfy the following conditions: 0≦α≦20, 0≦β≦20, 0≦γ≦20 (provided α, β and γ are not “0” at the same time), 40≦δ≦95, 0<ε≦10, 0≦ζ≦40, 0≦η≦10 and (α+β+γ+δ+ε+ζ+η)=100).

<6> The optical recording medium according to any one of <1> to <5>, wherein the recording layer performs at least one of a recording operation, an erasing operation and a rewriting operating by utilizing reversible phase change between amorphous and crystalline phases.

<7> The optical recording medium according to any one of <1> to <6>, wherein the thickness of the recording layer is 6 nm to 20 nm.

<8> The optical recording medium according to any one of <1> to <7>, wherein the first protective layer and the second protective layer comprise a mixture of ZnS and SiO₂. The first protective layer and the second protective layer in the optical recording medium according to <8> comprise a mixture of ZnS and SiO₂. The mixture of ZnS and SiO₂ imparts high heat resistance, low thermal conductivity, and excellent chemical stability to these protective layers. In such protective layers containing the mixture of ZnS and SiO₂, film residual stress is small and there is a low likelihood that recording characteristics (e.g., recording sensitivity and information-erasing rate) would be reduced after recording-erasing cycles. In addition, such protective layers are also advantageous in that they have excellent adhesion with the recording layer.

<9> The optical recording medium according to any one of <1> to <8>, wherein the reflective layer comprises one of Ag and an Ag alloy. In the optical recording medium according to <9>, Ag and an AG alloy have extremely high thermal conductivity and thus can realize a rapid cooling mechanism suitable for the formation of amorphous, by which the recording layer that has reached a high temperature is immediately cooled down. Thus, it is possible to form an excellent reflective layer.

<10> The optical recording medium according to any one of <1> to <9>, wherein a sulfur-free third protective layer is provided between the second protective layer and the reflective layer, and the sulfur-free third protective layer comprises at least one of SiC and Si. If a reflective layer contains Ag as does the recording of the optical recording medium according to <1>, the use of a sulfur-containing material (e.g., a mixture of ZnS and SiO₂) for the second protective layer causes sulfur to react with Ag, corroding the reflective layer. Sulfuration of Ag can be prevented by providing such a third protective layer between the second protective layer and the reflective layer. In this way it is possible to ensure the reliability of the optical recording medium.

<11> The optical recording medium according to any one of <1> to <10>, wherein an oxide-containing interface layer is provided at least between the recording layer and the first protective layer or between the recording layer and the second protective layer.

<12> The optical recording medium according to any one of <1> to <11>, wherein the reflectivity uniformity, expressed by the following Expression 1, of an initialized non-recorded portion to a recording and reproduction laser beam is 0.10 or less.
Reflectivity uniformity=(maximum reflectivity value−minimum reflectivity value)/average of reflectivity values. <Expression 1>

In the optical recording medium according to <12> the fluctuations in the reflectivity of initialized (or crystallized) portions significantly affect the recording characteristics, making it difficult to provide uniform recording characteristics over all date areas in the disc. It is possible to ensure uniform recording characteristics by setting the reflectivity uniformity—expressed by the foregoing Expression 1—to 0.10 or less.

<13> The optical recording medium according to any one of <1> to <12>, wherein the substrate comprises a wobble groove of 0.74±0.03 μm in pitch, 22 nm to 40 nm in depth, and 0.2 μm to 0.4 μm in width. With this optical recording medium according to <13> it is possible to provide a DVD+RW medium, which is compliant with the current DVD+RW standard and capable of high-speed recording. A wobble groove realizes accessing a particular non-recorded track, as well as rotation of the substrate at a constant linear velocity.

<14> The optical recording medium according to any one of <1> to <13>, capable of recording at 3× to 10×DVD recording speeds. The optical recording medium according to <14> is compliant with the current DVD+RW standard and can record at 3× to 10× recording speeds—about 10 m/s to 36 m/s.

<15> A sputtering target used for the production of a recording layer, the sputtering target having a composition expressed by the following Formula 1:
(X₁)_{α}Sb_{β}(X₂)_{γ} <Formula 1>

where X₁ represents at least one element selected from Ga, Ge and In; X₂ represents at least one element selected from Au, Ag and Cu; and α, β and γ represent atomic % of their respective elements (where 2≦α≦20, 55≦β≦95 , 0<γ≦10, and (α+β+γ)=100).

<16> A sputtering target used for the production of a recording layer, the sputtering target having a composition expressed by the following Formula 2:
(X₁)_{α}Sb_{β}(X₂)_{γ}-M_{δ} [Formula 2]

where X₁ represents at least one element selected from Ga, Ge and In; X₂ represents at least one element selected from Au, Ag and Cu; M represents at least one element selected from elements other than X₁, Sb and X₂ and mixtures of the elements other than X₁, Sb and X₂; and α, β, γ and δ represent atomic % of their respective elements (where 2≦α≦20, 55≦β≦95, 0<γ≦10, 0<δ≦40, and (α+β+γ+δ)=100).

<17> The sputtering target according to <16>, wherein M represents at least one element selected from Te, Al, Zn, Mg, Tl, Pb, Sn, Bi, Cd, Hg, Se, C, N, Mn and Dy.

<18> The sputtering target according to one of <16> and <17>, having a composition expressed by the following Formula 3:
(X₁)_{α}Sb_{β}(X₂)_{γ}—Sn_{δ} [Formula 3]

where X₁ represents at least one element selected from Ga, Ge and In; X₂ represents at least one element selected from Au, Ag and Cu; and α, β, γ and δ represent atomic % of their respective elements (where 2≦α≦20, 55≦β≦95, 0<γ≦10, 0<δ≦40, and (α+β+γ+δ)=100).

<19> The sputtering target according to any one of <15> to <18>, expressed by the formula Ga_{α}Ge_{β}In_{γ}—Sb_{δ}—(X₂)_{ε}Sn_{ζ}—Y_{η}

where X₂ represents at least one element selected from Au, Ag and Cu; Y represents at least one element selected from Te, Al, Zn, Mg, Tl, Pb, Bi, Cd, Hg, Se, C, N, Mn and Dy; and α, β, γ, δ, ε, ζ and η satisfy the following conditions: 0≦α≦20, 0≦β≦20, 0≦γ≦20 (provided α, β and γ are not “0” at the same time), 40≦δ≦95, 0≦ε≦10, 0≦ζ≦40, 0≦η≦10 and (α+β+γ+δ+ε+ζ+η)=100).

In the sputtering target according to any one of <15> to <18> it is possible to provide a desired recording layer composition by forming the recording layer with a sputtering method using an alloy target of desired composition. It is also possible to inexpensively provide an optical recording medium which can realize excellent recording characteristics and storage reliability even at high recording speeds of 3× to 10× on DVD, particularly at 8× or faster, and whose recording material can be readily initialized to provide a uniform reflectivity distribution.

<20> A method for manufacturing an optical recording medium, including: forming a recording layer with a sputtering method using a sputtering target according to any one of <15> to <19>.

In the method of the present invention for manufacturing an optical recording medium, a recording layer is formed with a sputtering method using the sputtering target of the present invention. Thus, it is possible to efficiently manufacture an optical recording medium which can realize excellent recording characteristics and storage reliability even at high recording speeds of 3× to 10× on DVD, particularly at 8× or faster, and whose recording material can be readily initialized to provide a uniform reflectivity distribution

<21> A method for using an optical recording medium, including: applying a laser beam onto an optical recording medium according to any one of <1> to <14> from the first protective layer side to perform at least one of a recording operation, an erasing operation and a rewriting operation.

In the method of the present invention for using an optical recording medium, a laser beam is applied onto the optical recording medium of the present invention from the first protective layer side to perform at least one of a recording operation, an erasing operation and a rewriting operation. Thus, it is possible to perform at least one of a recording operation, an erasing operation and a rewriting operation stably and reliably.

<22> An optical recording apparatus for applying a laser beam onto an optical recording medium from a laser beam source to thereby perform at least one of a recording operation, an erasing operation and a rewriting operation on the optical recording medium, wherein the optical recording medium is an optical recording medium according to any one of <1> to <14>.

In the optical recording apparatus of the present invention for applying a laser beam onto an optical recording medium from a laser beam source to thereby perform at least one of a recording operation, an erasing operation and a rewriting operation on the optical recording medium, the optical recording medium of the present invention is used. With this optical recording apparatus, it is possible to perform at least one of a recording operation, an erasing operation and a rewriting operation stably and reliably.

### BRIEF DESCRIPTION OF THE DRAWINGS

FIG. 1 is a schematic cross-sectional view of an example of an optical recording medium of the present invention.

FIG. 2 is a schematic cross-sectional view of another example of the optical recording medium of the present invention.

FIG. 3 is a schematic cross-sectional view of still another example of the optical recording medium of the present invention.

FIG. 4 is a schematic cross-sectional view of yet another example of the optical recording medium of the present invention.

FIG. 5 is an explanatory drawing of an example of the layer structure of a double-layer optical recording medium of the present invention.

FIG. 6 is an explanatory drawing of an example of the layer structure of the optical recording medium of the present invention.

FIG. 7 shows the state of an initialized recording layer in Comparative Example 1, observed with a transmission electron microscope.

FIG. 8 is a plot of optical disc reflectivities against irradiation beam linear velocities.

### DESCRIPTION OF THE PREFERRED EMBODIMENTS

(Optical Recording Medium)

The optical recording medium of the present invention comprises a substrate, a first protective layer on the substrate, a recording layer on the first protective layer, a second protective layer on the recording layer, and a reflective layer on the second protective layer. Alternatively, the optical recording medium of the present invention comprises a substrate, a reflective layer on the substrate, a second protective layer on the reflective layer, a recording layer on the second protective layer, and a first protective layer on the recording layer. The optical recording medium of the present invention comprises an additional layer on an as-needed basis.

The optical recording medium of the present invention is irradiated with a laser beam from the first protective layer side, whereby at least one of a recording operation, reproduction operation, erasing operation, and rewriting operation is performed.

—Recording Layer—

The recording layer is irradiated with a laser beam to switch between crystalline and amorphous phases, thereby recording and erasing signals. In this case, the crystalline phase and amorphous phase are different from each other in terms of reflectivity. In general, the crystalline phase with high reflectivity serves as a non-recorded area. A high-energy laser pulse is then applied to the crystalline phase to heat the recording layer, followed by rapid cooling down. In this way amorphous marks of low reflectivity are recorded as signals.

In the first embodiment, the recording layer of the optical recording medium of the present invention contains a composition expressed by the following Formula 1 as a phase-change material that can maintain excellent recording characteristics and storage reliability even at high recording speeds of 3× to 10× on DVD, particularly at 8× or faster, and whose recording material can be readily initialized to provide a uniform reflectivity distribution.
(X₁)_{α}Sb_{β}(X₂)_{γ} <Formula 1>

where X₁ represents at least one element selected from Ga, Ge and In; X₂ represents at least one element selected from Au, Ag and Cu; and α, β and γ represent atomic % of their respective elements (where 2≦α≦20, 55≦β≦95, 0<γ≦10, and (α+β+γ)=100)

In this case, the recording layer preferably contains a composition expressed by the Following formula (1-1).
(X₁)_{α}Sb_{β}(X₂)_{γ} <Formula 1-1>

where X₁ and X₂ are identical to those in Formula 1; and α, β, and γ represent atomic % of their respective elements (where 4≦α≦8, 84≦β≦92, 4≦γ≦8, and (α+β+γ)=100)

Phase-change materials that contain Sb, a main constituent of the recording layer, are excellent phase-change materials that can realize high-speed recording, and its crystallization rate can be adjusted by changing the Sb ratio; the higher the Sb ratio, the higher the crystallization rate. If Sb is used singly, however, it is difficult to provide recording layer materials with excellent storage reliability as well as with high crystallization rate that can support high-speed recording as fast as 8×DVD recording speed (about 28 m/s). For this reason, at least one element selected from Ga and In is added to the recording layer material to increase the crystallization rate without reducing overwrite characteristics and storage reliability. In addition, at least one element selected from Ge and In is added to the recording layer material to improve storage reliability. More preferably, Ge is added.

The element Ga can increase both the crystallization rate and crystallization temperature of phase-change material even when added in small amounts. Thus, the addition of Ga is highly effective to increase the stability (or storage reliability) of marks.

The element Ge—when added in small amounts—does not increase the crystallization rate but can significantly increase the storage reliability of marks without increasing the crystallization temperature to a level equal to or higher than that achieved by Ga. For this reason, Ge is also an important element, as is Ga.

The element In has a similar effect as Ga and increases the crystallization temperature to a level lower than that achieved by Ga. For this reason, in view of problems associated with initialization, it is effective to use In as a supportive element for Ga.

Accordingly, it is possible to design recording materials with have high crystallization rate and excellent storage reliability that can support high-speed recording, by changing the elemental ratios of X₁—Sb phase-change materials (where X₁ represents at least one element selected from Ga, Ge and In). As described above, these materials, however, have a drawback that they have high crystallization temperature, which leads to poor initialization performance.

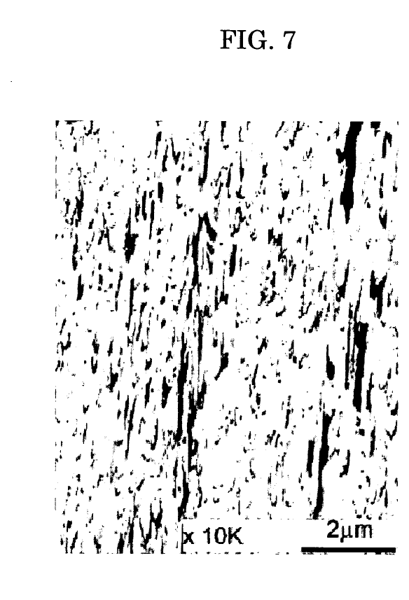

By changing the elemental ratios of Ga—Sb phase-change materials, Ge—Sb phase-change materials, and In—Sb phase-change materials, it is possible to design recording materials with high crystallization rate and excellent storage reliability that can support high-speed recording—specifically, recording speeds of 3× to 10× on DVD, particularly 8× or faster. As described above, these materials, however, have a drawback that they have high crystallization temperature, which leads to poor initialization. To avoid this problem, at least one element selected from Au, Ag and Cu is added to these phase-change materials. One of the reasons why poor initialization performance improves by the addition of at least one of these elements is that these elements exist as crystalline particles in the recording material and serve as “crystal nuclei” upon initialization to facilitate crystallization (see FIG. 7, which shows the state of an initialized recording layer observed with a transmission electron microscope).

Accordingly, it is possible to solve the problems associated with initialization of materials with high crystallization rates by adding at least one element selected from Au, Ag and Cu in the recording layer to form crystalline particles to thereby create “crystal nuclei” in the recording layer beforehand.

Crystalline metal particles are produced by the following Reaction 1:
nX₂⁰+heat→(X₂⁰)n (crystalline particles) [Reaction 1]
where X₂⁰ is a metal atom present in a recording layer

In addition, when a metal atom in a recording layer is present in the form of ions, crystalline particles may be produced by the following Reaction 2:
X₂+Sb²⁺+hν→X₂⁰+Sb⁴⁺ (reduction reaction by Sb) [Reaction 2]

This reduction reaction by Sb is generally a photosensitive reaction, and the reaction proceeds by the irradiation with ultraviolet rays or the like. In this case, for example, metal atoms are produced as a result of application of ultraviolet rays used for curing of ultraviolet-curable resin.

In each case, heat generated as a result of the application of laser during an initialization operation transforms the metal atom X₂⁰ present in the recording layer to crystalline metal particles as shown in Reaction 1, and the resultant particles that serve as “crystal nuclei” are uniformly dispersed in the recording layer. In this way it is possible to readily initialize recording material and to perform an initialization operation with a uniform reflectivity distribution.

Since Au, Ag and Cu are effective additive elements that can ensure storage reliability, it is possible to improve poor initialization performance and to design phase-change materials with excellent storage reliability.

Accordingly, the present invention focuses attention on the rapid crystallization characteristics of X₁—Sb compounds (where X₁ represents at least one element selected from Ga, Ge and In) used for recording layer materials, and utilizes the characteristics.

Meanwhile, poor initialization performance attributed to higher crystallization temperatures is successfully improved by adding at least one element selected from Au, Ag and Cu to the recording layer material to form crystalline particles therein. Thus, it is made possible to provide an optical recording medium which can realize high-speed recording and high storage reliability and whose recording material can be readily initialized to provide a uniform reflectivity distribution.

In order to design phase-change materials suitable for high-speed recording at as fast as 3× to 10×DVD recording speeds, particularly at 8× or faster, the added amount or level (ν) of any one of Au, Ag and Cu in the recording layer material is set to 10 atomic % or less. Although these elements provide excellent storage reliability and are effective for improving poor initialization performance of high-speed recording materials, they also reduce the crystallization rate of the recording layer material to prevent high-speed recording. For this reason, if the level of any one of Au, Ag and Cu in the recording layer material is greater than 10 atomic %, it becomes difficult to design phase-change materials suitable for high-speed recording of 8× on DVD. Thus, the upper limit of the level of any one of Au, Ag and Cu in the recording layer material needs to be 10 atomic % or less; however, the lower limit is preferably 1 atomic % because when added in small amounts, effects brought about by Au, Ag or Cu may be unclear.

With respect to the elemental ratios of Sb, Ga, Sb and Ge, α in the foregoing Formula 1 needs to be 2 or greater. For example, if X₁ represents at least one of Ga and In and α is less than 2, or if β is less than 55, it results in reduction in the crystallization rate and it becomes difficult to perform an overwrite operation at a linear velocity of 28 m/s or less, which is equivalent to 8×DVD recording speed. In addition, if α is less than 2, it results in poor storage reliability. At least one of Ga and In can increase the crystallization rate even when added in small amounts. In particular, Ga has an effect of increasing the crystallization temperature of phase-change materials and serves as an element that can effectively improve the stability of marks. However, if α in Formula 1 is greater than 20, it becomes difficult to initialize recording material. In particular, if Ga is added in small amounts, the crystallization temperature becomes so high that it is difficult to obtain a crystalline phase with a high, uniform reflectivity distribution upon initialization. Meanwhile, In has a similar effect as Ga and increases the crystallization temperature to a level lower than that achieved by Ga. For this reason, in view of problems associated with initialization, it is effective to use In as a supportive element for Ga. In, however, reduces the repetitive recording characteristics and causes a reduction in reflectivity when added in excessive amounts; therefore, it should be added at a level of 20 atomic % or less.

When X₁ represents Ge only, it is possible to realize recording material especially excellent in storage reliability because Ge can, even when added in small amounts, significantly increase the storage reliability without increasing the crystallization temperature to a level equal to or higher than that achieved by Ga. Ge has a specific effect of stabilizing amorphization of a recording layer having high crystallization rate, and such an effect is brought about when it is added at a level of 2 atomic % or more; the greater the level, the greater the effect. Ge, however, has a harmful effect that it reduces the crystallization rate and, when added in excessive amounts, causes an increase in jitter as a result of overwriting; therefore, it should be added at a level of 20 atomic % or less. Even when the level of Ge is 20 atomic %, the crystallization rate increases rapidly, mark formation becomes difficult, and storage reliability is reduced, if β is greater than 95. Thus, β should be 95 or less.

If X₁ represents Ge and at least one of Ga and In, it is also possible to obtain excellent storage reliability by reducing the level of at least one of Ga and In, by increasing the level of Ge to compensate this reduction, and by setting a to 2 or greater.

In the second embodiment, the recording layer of the optical recording medium of the present invention contains a composition expressed by the following Formula 2
(X₁)_{α}Sb_{β}(X₂)_{γ}-M_{δ} <Formula 2>

where X₁ represents at least one element selected from Ga, Ge and In; X₂ represents at least one element selected from Au, Ag and Cu; M represents at least one element selected from elements other than X₁, Sb and X₂ and mixtures of the elements other than X₁, Sb and X₂; and α, γ, γ and δ represent atomic % of their respective elements (where 2≦α≦20, 55≦β≦95, 0<γ≦10, 0<δ≦40, and (α+β+γ+δ)=100)

In this case, the recording layer preferably contains a composition expressed by the Following formula (2-1).
(X₁)_{α}Sb_{β}(X₂)_{γ}-M_{δ} <Formula 2-1>

where X₁ and X₂ are identical to those in Formula 2; and α, β, γ and δ represent atomic % of their respective elements (where 4≦α≦8, 65≦β≦83, 4≦γ≦8, 1≦δ≦20, and (α+β+γ+δ)=100)

Here, the descriptions for X₁ and X₂ in the foregoing Formulae 2 and 2-1 are similar to those provided in the first embodiment.

The recording layer preferably contains a composition expressed by the following Formula 3, where M is replaced with Sn in Formula 2. By adding Sn in Ga—Sb materials as an essential element as described above, it is possible to provide an optical recording medium which can ensure excellent recording characteristics and storage reliability even at high recording speeds of 8× or faster on DVD.
(X₁)_{α}Sb_{β}(X₂)_{γ}—Sn_{δ} <Formula 3>

where X₁ and X₂ are identical to those in Formula 2; and α, β, γ and δ represent atomic % of their respective elements (where 2≦α≦20, 55≦β≦95, 0<γ≦10, 0<6<δ≦40, and (α+β+γ+δ)=100)

The recording layer is expressed by the formula Ga_{α}Ge_{β}In_{γ}—Sb_{δ}—(X₂)_{ε}Sn_{ζ}—Y_{η} (where X₂ represents at least one element selected from Au, Ag and Cu; Y represents at least one element selected from Te, Al, Zn, Mg, Tl, Pb, Bi, Cd, Hg, Se, C, N, Mn and Dy; and α, β, γ, δ, ε, ζ and η preferably satisfy the following conditions: 0≦α≦20, 0≦β≦20, 0≦γ≦20 (provided α, β and γ are not “0” at the same time), 40≦δ≦95, 0<ε≦10, 0≦ζ≦40, 0≦η≦10 and (α+β+γ+δ+ε+ζ+η)=100).

With respect to the elemental ratios of Sb, Ga, Ge and In, if none of Ga, Ge and In is present, i.e., (α+β+γ)=0, it may result in poor storage reliability. If δ is greater than 95, the crystallization rate increases rapidly, mark formation becomes difficult, and storage reliability is reduced, which are undesirable. If the level of Ga is too high, the crystallization temperature becomes so high that it is difficult to obtain a crystalline phase with a high, uniform reflectivity distribution upon initialization. For this reason, the level of Ga is preferably 20 atomic % or less. Meanwhile, Ge provides an effect of improving storage reliability when added at a level of about 2 atomic %; the greater the level, the greater the effect. Ge, however, has a harmful effect that it increases jitter as a result of overwriting when added in excessive amounts; therefore, it should also be added at a level of 20 atomic % or less. Meanwhile, In has a similar effect as Ga and increases the crystallization temperature to a level lower than that achieved by Ga. For this reason, in view of problems associated with initialization, it is effective to use In as a supportive element for Ga. In, however, reduces the repetitive recording characteristics and causes a reduction in reflectivity when added in excessive amounts; therefore, it should be added at a level of 20 atomic % or less. The level of Sn is preferably 40 atomic % or less because it results in poor reproduction beam quality, poor jitter performace, and poor storage reliability when added in excessive amounts.

M preferably represents at least one element selected from Te, Al, Zn, Mg, Tl, Pb, Sn, Bi, Cd, Hg, Se, C, N, Mn and Dy. Each of these elements has its own effect of improving the recording characteristics and storage reliability and thus can improve the characteristics of X₁—Sb—X₂ alloys when added at appropriate amounts.

In addition to Ga and In, Tl, Pb, Sn, Bi, Al, Zn, Mg, Cd and Hg also have an effect of increasing crystallization limitation velocity. Among these elements, Sn—an element with an atomic number closest to that of Sb and potentially has a high compatibility with Sb—is preferably used, increasing the crystallization limitation velocity and improving overwriting characteristics. The level of any of these elements is preferably 40 atomic % or less because it results in poor reproduction beam quality and poor jitter performance when added in excessive amounts.

In addition to Ge, Al, C, N and Se also have an effect of improving storage reliability. Moreover, Al and Se contribute to rapid crystallization, and Se contributes to an increase in the recording sensitivity.

Furthermore, Mn and Dy have a similar effect as In. In particular, Mn is an element excellent in storage reliability that eliminates the need to increase the level of Ge too high. The optimal level of Mn is 1 atomic % to 15 atomic %; if the level is less than 1 atomic %, Mn never exhibits such an effect, whereas if the level is greater than 15 atomic %, it results in too low reflectivity in non-recorded portions (crystalline portions).

For the method for forming the recording layer, various vapor deposition methods can be used—vacuum deposition, sputtering method, plasma CVD, photo CVD, ion plating, electron-beam deposition, or the like. Among these methods, the sputtering method is excellent in terms of mass-productivity and film quality.

The thickness of the recording layer is not particularly limited and can be appropriately determined depending on the intended purpose; it is preferably 6 nm to 20 nm. If the thickness of the recording layer is less than 6 nm, it results in a significant reduction in the repetitive recording characteristics, whereas if the thickness of the recording layer is greater than 20 nm, it results in an increase in the likelihood of recording layer shifting as a result of overwriting, causing a significant increase in jitter. Moreover, in order to increase information-erasing characteristics by minimizing the difference in light-absorption between the crystalline and amorphous phases, the recording layer is preferably made thin. Thus, a preferable thickness range is 8 nm to 16 nm.

Next, examples of the layer structure of the optical recording medium of the present invention will be described with reference to the drawings.

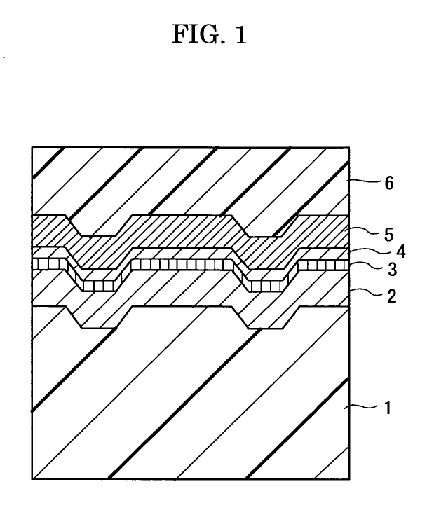

FIG. 1 is a schematic cross-sectional view of an example of the optical recording medium of the present invention, where a substrate 1 is provided, and a first protective layer 2, recording layer 3, second protective layer 4, reflective layer 5 and resin protection layer 6 are sequentially formed on the substrate 1.

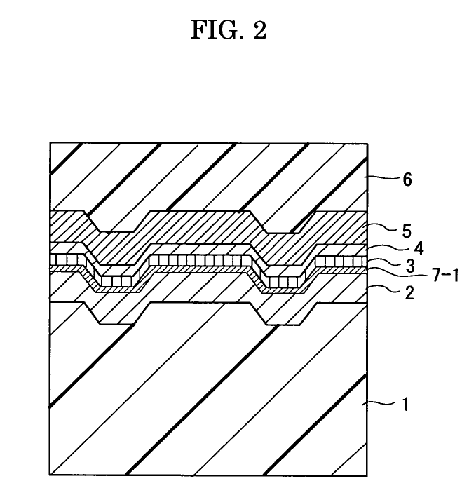

FIG. 2 is a schematic cross-sectional view of another example of the optical recording medium of the present invention, where a substrate 1 is provided, and a first protective layer 2, interface layer 7-1, recording layer 3, second protective layer 4, reflective layer 5 and resin protection layer 6 are sequentially formed on the substrate 1.

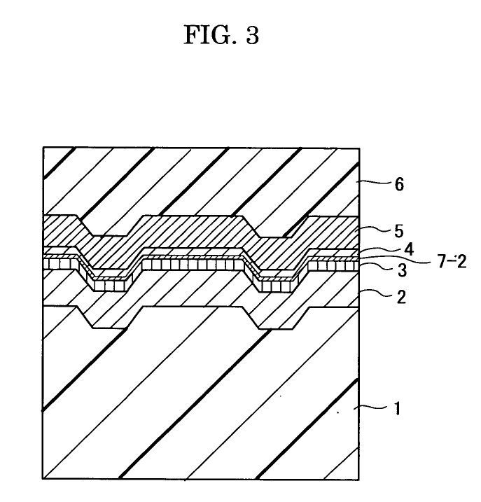

FIG. 3 is a schematic cross-sectional view of still another example of the optical recording medium of the present invention, where a substrate 1 is provided, and a first protective layer 2, recording layer 3, interface layer 7-2, second protective layer 4, reflective layer 5 and resin protection layer 6 are sequentially formed on the substrate 1.

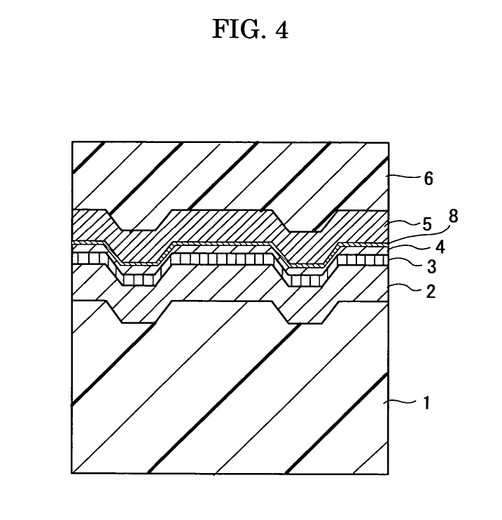

FIG. 4 is a schematic cross-sectional view of yet another example of the optical recording medium of the present invention, where a substrate 1 is provided, and a first protective layer 2, recording layer 3, second protective layer 4, third protective layer 8, reflective layer 5 and resin protection layer 6 are sequentially formed on the substrate 1.

Note that another substrate may be bonded to the resin protection layer 6 on an as-needed basis for further reinforcement or protection of the optical recording medium.

—Substrate—

The substrate 1 needs to be made of material that can ensure the mechanical strength of the optical recording medium. Moreover, when a recording beam and reproduction beam are incident to the optical recording medium after passing through the substrate 1, the substrate 1 needs be transparent enough to admit beams of desired wavelengths.

Examples of materials for the substrate include glass, ceramics and resins; a substrate made of resin is preferably used in view of the formability and costs of resin. Examples of the resins include polycarbonate resins, acrylic resins, epoxy resins, polystyrene resins, acrylonitrile-styrene copolymers, polyethylene resins, polypropylene resins, silicone resins, fluorine resins, ABS resins and urethane resins. Among these, polycarbonate resins and acrylic resins are most preferable in view of their formability, optical characteristics, and costs.

The thickness of the substrate 1 is not particularly limited, and is generally determined depending on the wavelength of laser beam used and on light-condensing characteristics of a pickup lens. In CDs where a beam of 780 nm wavelength is used, a substrate of 1.2 mm thickness is employed. In DVDs where a beam of 650 nm to 665 nm wavelength is used, a substrate of 0.6 mm thickness is employed.

For the substrate, a substrate made of polycarbonate resin is preferably used that is excellent in processibility and optical characteristics. For example, such a substrate is a disc of 12 cm in diameter and 0.6 mm in thickness, which has a tracking groove on its surface. The tracking groove is preferably a wobble groove with the following specification: pitch=0.74±0.03 μm; depth=22 nm to 40 nm; and width=0.2 μm to 0.4 μm. The wobble groove realizes accessing a particular non-recorded track, as well as rotation of the substrate at a constant linear velocity. In addition, increasing the depth of the grooves leads to a reduction in reflectivity of the optical recording medium, making it possible to increase the degree of modulation.

Note that an adhesion layer—a layer that serves to bond the substrate 1 that records information signals to a dummy substrate—is formed of any of a two-sided sheet, in which an adhesive is applied on both sides of the base film, thermosetting resin, and ultraviolet-curable resin. The thickness of the adhesion layer is generally around 50 μm.

The dummy substrate is not necessarily transparent in a case where an adhesive sheet or thermosetting resin is used as an adhesion layer. However, the dummy substrate is preferably transparent in a case where ultraviolet-curable resin is used as the adhesion layer. In general, the thickness of the dummy substrate is preferably 0.6 mm like the transparent substrate 1 in which information signals are to be written.

—First Protective Layer—

Preferably, the first protective layer 2 bonds well to the substrate and recording layer and has high heat resistance. Moreover, since the first protective layer 2 also serves as an optical interference layer that enables the recording layer to efficiently absorb light, it preferably has optical characteristics suitable for repetitive recording at high linear velocities.

Examples of materials of the first protective layer include metal oxides such as SiO, SiO₂, ZnO, SnO₂, Al₂O₃, TiO₂, In₂O₃, MgO and ZrO₂; nitrides such as Si₃N₄, AlN, TiN, BN and ZrN; sulfides such as ZnS, In₂S₃ and TaS₄; carbides such as SiC, TaC, B₄C, WC, TiC and ZrC; diamond carbon; and mixtures thereof. Among these, mixtures of ZnS and SiO₂ are preferable; the molar ratio between ZnS and SiO₂ (ZnS:SiO₂) is preferably 50 to 90:50 to 10, more preferably 60 to 90:40 to 10.

For the method for forming the first protective layer 2, various vapor deposition methods can be used—vacuum deposition, sputtering method, plasma CVD, photo CVD, ion plating, electron-beam deposition, or the like. Among these methods, the sputtering method is excellent in terms of mass-productivity and film quality.

The thickness of the first protective layer 2 is not particularly limited and can be appropriately determined depending on the intended purpose; it is preferably 40 nm to 200 nm, more preferably 40 nm to 100 nm. If the thickness of the first protective layer 2 is less than 40 nm, the substrate may become deformed because the substrate is also heated when the recording layer is heated. If the thickness of the first protective layer 2 is greater than 200 nm, the mechanical strength of the disc may be reduced to cause, for example, disc warpage.

—Second Protective Layer—

Preferably, the second protective layer 4 bonds well both to the substrate and recording layer and has high heat resistance. Moreover, since the first protective layer 2 also serves as an optical interference layer that enables the recording layer to efficiently absorb light, it preferably has optical characteristics suitable for repetitive recording at high linear velocities.

Examples of materials for the second protective layer 4 include metal oxides such as SiO, SiO₂, ZnO, SnO₂, Al₂O₃, TiO₂, In₂O₃, MgO and ZrO₂; nitrides such as Si₃N₄, AlN, TiN, BN and ZrN; sulfides such as ZnS, In₂S₃ and TaS₄; carbides such as SiC, TaC, B₄C, WC, TiC and ZrC; diamond carbon; and mixtures thereof. Among these, mixtures of ZnS and SiO₂ are preferable; the molar ratio between ZnS and SiO₂ (ZnS:SiO₂) is preferably 50 to 90:50 to 10, more preferably 60 to 90:40 to 10.

For the method for forming the second protective layer 4, various vapor deposition methods can be used—vacuum deposition, sputtering method, plasma CVD, photo CVD, ion plating, electron-beam deposition, or the like. Among these methods, the sputtering method is excellent in terms of mass-productivity and film quality.

The thickness of the second protective layer 4 is preferably 2 nm to 20 nm. Since the second protective layer significantly affects the cooling down of the recording layer, the second protective layer needs to be 2 nm or more in thickness in order to ensure excellent information-erasing characteristics and repetitive recording durability. If the thickness of the second protective layer is less than 2 nm, it results in defects such as cracks and repetitive recording durability is reduced. Moreover, it results in poor recording sensitivity. If the thickness of the second protective layer is greater than 20 nm, the cooling rate for the recording layer is reduced and mark formation becomes difficult, leading to small mark areas.

—Reflective Layer—

The reflective layer 5 functions not only as a light reflection layer, but also as a heat-dissipating layer for dissipating heat applied to the recording layer as a result of laser beam irradiation during an recording operation. For the cooling achieved by heat dissipation, the rate of which significantly affects the formation of amorphous marks. For this reason, selecting an appropriate reflective layer is important with respect to phase-change optical recording media that can support high linear velocity.

Examples of the materials for the reflective layer 5 include metals such as Al, Au, Ag, Cu and Ta and alloys thereof. In addition, Cr, Ti, Si, Cu; Ag, Pd, Ta and the like can be added to these metals as an additive element. Among these, the reflective layer 5 preferably contains either Ag or an Ag alloy. This is because, in general, the reflective layer constituting the optical recording medium is preferably made of metal with high thermal conductivity and reflectivity from the view point of controlling the rate of removal of heat generated upon recording as well as from the optical view point of increasing the contrast of reproduction signals by utilizing interference effects, and because both Ag and an Ag alloy have a thermal conductivity of as high as 427 W/mK and thus can realize a rapid cooling mechanism suitable for the formation of amorphous, by which the recording layer that has reached a high temperature is immediately cooled down.

Although pure Ag is the best choice in light of its high thermal conductivity, Cu may be added to it in order to impart corrosion resistance. At this point, the level of Cu is preferably 0.1 atomic % to 10 atomic %, more preferably 0.5 atomic % to 3 atomic % so as not to adversely affects the characteristics of Ag. When Cu is added in excessive amounts, the thermal conductivity of Ag may be reduced.

The reflective layer 5 is formed with any of various vapor deposition methods—vacuum deposition, sputtering method, plasma CVD, photo CVD, ion plating, electron-beam deposition or the like. Among these methods, the sputtering method is excellent in terms of mass-productivity and film quality.

In general, the thickness of the reflective layer is preferably 100 nm to 300 nm. If the thickness the reflective layer is less than 100 nm, the reflective layer may not sufficiently exert its function as a reflective layer. If the thickness of the reflective layer is greater than 300 nm, it may result in poor productivity or the mechanical strength of the disc may be reduced to cause, for example, disc warpage.

—Third Protective Layer—

As shown in FIG. 4, the third protective layer 8 is preferably provided between the second protective layer 4 and the reflective layer 5.

Examples of the materials for the third protective layer 8 include Si, SiC, SiN, SiO₂, TiC, TiO₂, TiC—TiO₂, NbC, NbO₂, NbV—NbO₂, Ta₂O₅, Al₂O₃, ITO, GeN and ZrO₂. Among these, TiC—TiO₂, Si or SiC is preferably in light of their high barrier properties.

When a reflective layer containing pure Ag or an Ag alloy and a protective layer containing sulfur (e.g., a mixture of ZnS and SiO₂) are used, diffusion of sulfur into Ag occurs to cause disc defects (i.e., sulfuration of Ag). Thus, appropriate materials that satisfy the following requirements need to be chosen for the third protective layer 3 for preventing the occurrence of such a reaction: (1) barrier properties to prevent the sulfuration of Ag; (2) optical admittance of laser beams; (3) low thermal conductivity for the formation of amorphous marks; (4) excellent adhesiveness to the protective layer and/or reflective layer; and (5) excellent formability, for example. Materials containing TiC—TiO₂, Si or SiC as a main constituent are preferable for the third protective layer.

For the method for forming the third protective layer, various vapor deposition methods can be used—vacuum deposition, sputtering method, plasma CVD, photo CVD, ion plating, electron-beam deposition, or the like. Among these methods, the sputtering method is excellent in terms of mass-productivity and film quality.

The thickness of the third protective layer is preferably 2 nm to 20 nm, more preferably 2 nm to 10 nm. If the thickness of the third protective layer is less than 2 nm, the third protective layer may not function as a barrier layer. If the thickness of the third protective layer is greater than 20 nm, there is a likelihood that modulation degree may be reduced.

—Interface Layer—

As shown in FIGS. 2 and 3, the interface layer 7-1 or interface layer 7-2 is preferably provided at least between the first protective layer 1 and recording layer 3 or between the recording layer and second protective layer. Preferably, the interface layer is made of at least one compound selected from ZrO₂, TiO₂, SiO₂, Al₂O₃, Ta₂O₅, Y₂O₃, MgO, CaO, Nb₂O₅ and rare earth oxides. Among these, SiO₂ is most preferable.

The thickness of the interface layer is preferably 2 nm to 10 nm. By this, it is possible to reduce the damage of the substrate caused as a result of high-power recording, thereby achieving excellent repetitive recording characteristics upon high-power recording. Thus, a wide recording power margin can be ensured. If the thickness of the interface layer is less than 2 nm, it may become difficult to form the interface layer uniformly, whereas if the thickness of the interface layer is greater than 10 nm, the formed interface layer may be likely to fall off the substrate.

It should be noted that the resin protective layer 6 can be provided on the reflective layer 5 on an as-needed basis. The resin protective layer 6 serves to protect the recording layer during the manufacturing process or after the product is in service, and is generally formed of ultraviolet-curable resin. The thickness of the resin protective layer is preferably 2 μm to 5 μm.

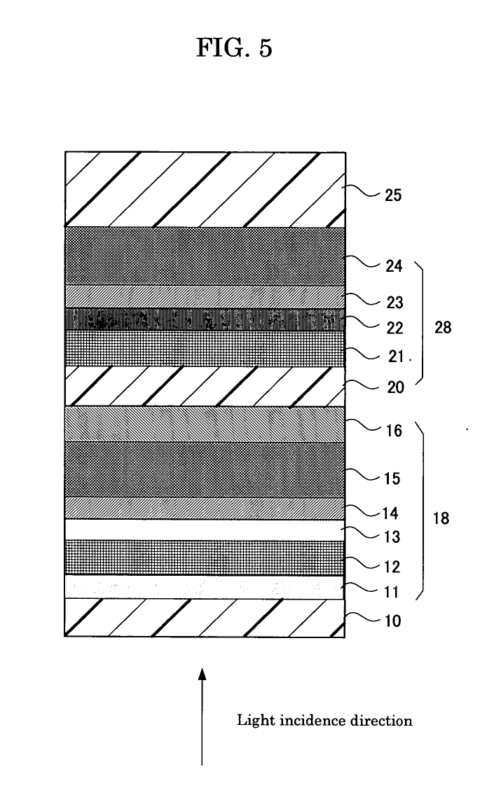

The optical recording medium of the present invention can also suitably be used as a multilayer optical recording medium. For example, FIG. 5 is a schematic cross-sectional view of a double-layer optical recording medium which sequentially includes on a first substrate 10 a first information layer 18, intermediate layer 20, second information layer 28 and second substrate 25, and further includes an additional layer on an as-needed basis.

The first information layer 18 includes an adhesion layer 11, first lower protective layer 12, first recording layer 13, first upper protective layer 14, first reflective layer 15, and heat dissipation layer 16.

The second information layer 28 includes a second lower protective layer 21, second recording layer 22, second upper protective layer 23, and second reflective layer 24.

Note that a barrier layer may be provided between the first upper protective layer 14 and first recording layer 15 and between the second upper protective layer 23 and second reflective layer 24.

In the present invention it is preferable that at least one of the first recording layer and second recording layer contains a recording material of the present invention expressed by X₁—Sb—X₂—Sn.

This multilayer optical recording medium realizes high-capacity recording.

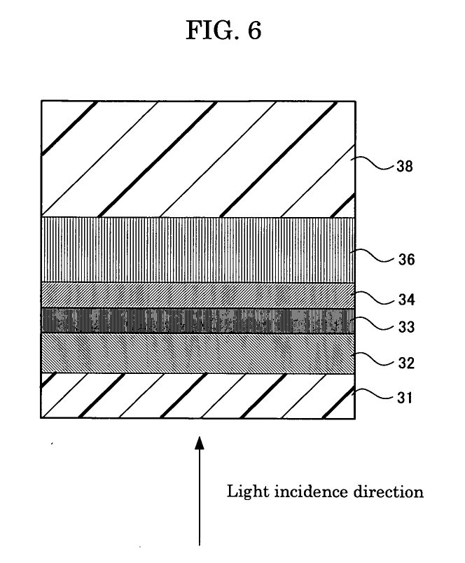

The optical recording medium of the present invention has been described above. The present invention is not limited to the embodiments described above, and various modifications can be made without departing the scope of the present invention. For example, the present invention can be applied in any form to a general Blu-Ray optical recording medium as shown in FIG. 6, which has a layered structure in which the first protective layer 32, recording layer 33, second protective layer 34, reflective layer 36, and dummy substrate 38 are sequentially provided on the substrate 31.

(Sputtering Target)

The sputtering target of the present invention is used for the production of a recording layer, and in the first embodiment, contains a composition expressed by the following Formula 1.
(X₁)_{α}Sb_{β}(X₂)_{γ}

where X₁ represents at least one element selected from Ga, Ge and In; X₂ represents at least one element selected from Au, Ag and Cu; and α, β and γ represent atomic % of their respective elements (where 2≦α≦20, 55≦β≦95, 0<γ≦10, and (α+β+γ)=100)

In this case, the sputtering target preferably contains a composition expressed by the Following formula (1-1).
(X₁)_{α}Sb_{β}(X₂)_{γ} <Formula 1-1>

where X₁ and X₂ are identical to those in Formula 1; and α, β, and γ represent atomic % of their respective elements (where 4≦α≦8, 84≦β≦92, 4≦γ≦8, and (α+β+γ)=100)

Moreover, in the second embodiment the sputtering target of the present invention used for the production of a recording layer contains a composition expressed by the following Formula 2.
(X₁)_{α}Sb_{β}(X₂)_{γ}-M_{δ}

where X₁ represents at least one element selected from Ga, Ge and In; X₂ represents at least one element selected from Au, Ag and Cu; M represents at least one element selected from elements other than X₁, Sb and X₂ and mixtures of the elements other than X₁, Sb and X₂; and α, β, γ and δ represent atomic % of their respective elements (where 2≦α≦20, 55≦β≦95, 0<γ≦10, 0<δ≦40, and (α+β+γ+δ)=100)

In this case, the sputtering target preferably contains a composition expressed by the Following formula (2-1).
(X₁)_{α}Sb_{β}(X₂)_{γ}-M_{δ} <Formula 2-1>

where X₁ and X₂ are identical to those in Formula 2; and α, β, γ and δ represent atomic % of their respective elements (where 4≦α≦8, 65≦β≦83, 4≦γ≦8, 1≦δ≦20, and (α+β+γ+δ)=100)

In addition, M preferably represents at least one element selected from Te, Al, Zn, Mg, Tl, Pb, Sn, Bi, Cd, Hg, Se, C, N, Mn and Dy.

The sputtering target preferably contains a composition expressed by the following Formula 3, where M is replaced with Sn in Formula 2.
(X₁)_{α}Sb_{β}(X₂)_{γ}—Sn_{δ} [Formula 3]

where X₁ and X₂ are identical to those in Formula 2; and α, β, γ and δ represent atomic % of their respective elements (where 2≦α≦20, 55≦β≦95, 0<γ≦10, 0<δ≦40, and (α+β+γ+δ)=100)

The sputtering target is expressed by the formula Ga_{α}Ge_{β}In_{γ}—Sb_{δ}—(X₂)_{ε}Sn_{ζ}—Y_{η} (where X₂ represents at least one element selected from Au, Ag and Cu; Y represents at least one element selected from Te, Al, Zn, Mg, Ti, Pb, Bi, Cd, Hg, Se, C, N, Mn and Dy; and α, β, γ, δ, ε, ζ and η preferably satisfy the following conditions: 0≦α≦20, 0≦β≦20, 0≦γ≦20 (provided α, β and y are not “0” at the same time), 40≦δ≦95, 0<ε≦10, 0≦ζ≦40, 0≦η≦10 and (α+β+γ+δ+ε+ζ+η)=100).

The method for producing the sputtering target is not particularly limited and can be appropriately determined depending on the intended purpose; a predetermined amount of sputtering target is measured into a glass ample, and is heated to melt. Thereafter, the resultant sputtering target is pulverized with a pulverizer, and the resultant power is heated and baked to provide a disc-shaped sputtering target.

According to the present invention, it is possible to provide an optical recording medium which is suitable for high-speed recording at a speed of 8× on DVD, particularly at 8× or faster, even though its capacity is as high as that of DVD-ROM, and which has a uniform reflectivity distribution after initialized.

According to the present invention, it is also possible to provide an optical recording medium with excellent repetitive recording characteristics over a wide recording linear velocity range, even though its capacity is as high as that of DVD-ROM, as well as a sputtering target used for the manufacturing of the optical recording medium.

(Method for Manufacturing Optical Recording Media)

The method of the present invention for manufacturing optical recording media includes at least a recording layer-formation step. In addition, this method includes an initial crystallization step, and further includes an additional step on an as-needed basis.

—Recording Layer-Formation Step—

The recording layer-formation step is a step for forming a recording layer with a sputtering method using the sputtering target of the present invention.

The sputtering method is not particular limited and can be appropriately selected from those known in the art; for example, sputtering is preferably performed under the following conditions: Deposition gas=Ar gas; Input voltage=1 kW to 5 kW; and Deposition gas flow rate=10 sccm to 40 sccm. The Ar gas pressure inside the chamber during sputtering is preferably 7.0×10⁻³ mTorr (mbar) or less.

—Initial Crystallization Step—

The initial crystallization step is a step for performing an initial crystallization operation at a predetermined power density to an optical recording medium rotating at a predetermined linear velocity.

In general, vapor deposition methods are used for the deposition of layers in a disc having a configuration as described above, and vapor deposition is performed at low temperatures because a resin-made substrate is used. Accordingly, since the freshly prepared recording layer is one which has just been cooled from a high-energy gaseous phase, it is amorphous and thus has low reflectivity. Thus, it is preferable to form amorphous marks in the crystalline recording layer to keep the reflectivity of the optical recording medium higher. To achieve this, initialization is required to crystallize information recording areas of the disc. The initialization operation is performed by applying a large-diameter, high-output laser beam on the periphery of the recording layer, melting the recording layer, and gradually cooling down the recording layer. Although any high-output laser beam and optical system can be employed, a laser beam of about 800 nm wavelength is generally employed. The output of the laser beam is preferably 500 mW to 3,000 mW, more preferably 1,000 mW to 2,500 mW. The beam spot is preferably 0.5 μm to 2.0 μm in the direction in which it is moved, and 30 μm to 200 um in the direction perpendicular to the direction in which it is moved. The use of such a rectangular or oval beam spot can widen the irradiation area. In view of the thermal and optical characteristics of the optical recording medium, it is necessary to set an optimal scanning speed and irradiation power.

In the optical recording medium the reflectivity uniformity—expressed by the following Expression 1—is preferably 0.10 or less, more preferably 0.05 or less to recording and reproduction laser beams of, for example, 600 nm wavelength applied to the initialized non-recorded portions (crystalline portions). If the reflectivity uniformity of after initialization is 0.10 or less, it is possible to ensure uniform recording characteristics on the entire surface of the disc
Reflectivity uniformity=(maximum reflectivity value−minimum reflectivity value)/average of reflectivity values <Expression 1>

The optical recording medium preferably has a reflectivity of 18% or more, more preferably 20% or more to recording and reproduction laser beams of, for example, 600 nm wavelength applied to the initialized non-recorded portions. If the reflectivity of the optical recording medium to these laser beams is less than 18%, reproduction and recording of signals may become difficult.

(The Method for Using Optical Recording Media)

The method of the present invention for using optical recording media performs at least one of a recording operation, reproduction operation, erasing operation, and rewriting operation.

In this case, the recording linear velocity of an optical recording medium is preferably equivalent to 8×DVD recording speed—about 28 m/s.

More specifically, a recording laser beam (e.g., a semiconductor laser beam) is applied through an objective lens onto an optical recording medium from the substrate side, while rotating the optical recording medium at a predetermined linear velocity. The recording layer absorbs the applied laser beam and shows a local temperature increase, forming marks with different optical characteristics, for example. In this way information is recorded. The information thus recorded can be reproduced by applying a laser beam onto the optical recording medium rotating at a predetermined linear velocity from the substrate side, and detecting the reflected light beams.

(Optical Recording Apparatus)

The Optical recording apparatus of the present invention is one which records information on an optical recording medium by irradiating it with a laser beam emitted from a laser beam source, wherein the optical recording medium of the present invention is used as the optical recording medium.

The optical recording apparatus of the present invention is not particularly limited and can be appropriately selected depending on the intended purpose. For example, the optical recording apparatus of the present invention includes a laser beam source such as a semiconductor laser beam source for emitting a laser beam; a collective lens for collecting the laser beam from the laser beam source onto an optical recording medium attached to the spindle; an optical device for guiding the laser beam from the laser beam source both to the collective lens and a laser beam detector; and the laser beam detector for detecting reflected beams, and further includes an additional unit on an as-needed basis.

The optical recording apparatus uses the optical device to guide the laser beam emitted from the laser beam source to the collective lens, and records information on the optical recording medium by collecting the laser beam with the collective lens and applying the collected laser beam onto the optical recording medium. At this point, the optical recording apparatus guides reflected beams to the laser beam detector, controlling the light intensity of the laser beam source on the basis of the intensity of laser beam detected by the laser beam detector.

The laser beam detector converts the laser beam intensity into voltage or current and outputs it as an intensity signal.

Examples of the additional unit include a control unit; such a control unit is not particularly limited as long as it can control each unit, and can be appropriately selected depending on the intended purpose. For example, equipment such as sequencers and computers for applying an intensity-modulated laser beam can be used.

According to the present invention, it is possible to provide an optical recording medium which can maintain excellent recording characteristics and storage reliability even at high recording speeds of 3× to 10× on DVD, particularly at 8× or faster, and whose recording material can be readily initialized to provide a uniform reflectivity distribution.

Hereinafter, the present invention will be described in detail with reference to Examples, which however shall not be construed as limiting the invention thereto.

### EXAMPLE 1

—Preparation of Optical Recording Medium—

With a sputtering method (using Big Sprinter, a sputtering device manufactured by Unaxis, Co. Ltd.), a first protective layer, recording layer, second protective layer, third protective layer, and reflective layer were sequentially deposited on a substrate.

At first, a polycarbonate resin substrate of 12 cm in diameter and 0.6 mm in thickness having a pattern of grooves with constant track pitch of 0.74 μm was prepared.

Next, with a sputtering method using a sputtering target of (ZnS)₈₀(SiO₂)₂₀ (mole %), the first protective layer was deposited on the substrate to a thickness of 65 nm.

Next, with a sputtering method using a sputtering target of Ga₉Sb₈₆Ag₅ (atomic %), the recording layer was deposited on the first protective layer to a thickness of 16 nm. Here, sputtering was performed under the following conditions: Ar gas pressure=3.0×10⁻³ Torr; and DC power=1.0 kW. Note that the target of the recording layer was rendered disc shape by measuring a predetermined amount of sputtering target into a glass ample, heating it to melt, pulverizing the resultant sputtering target with a pulverizer, and heating and baking the resultant power. The elemental ratio of the deposited recording layer analyzed by inductively coupled plasma (ICP) emission spectrophotometric analysis was determined to be identical to that of the sputtering target measured into the glass ample. A sequential ICP emission spectrophotometric analyzer (SPS4000, manufactured by Seiko Instruments, Inc.) was used for this analysis. It should be noted also in Examples and Comparative Examples to be described later that the alloy composition of the recording layer is identical to that of the sputtering target.

Next, with a sputtering method using a sputtering target of (ZnS)₈₀(SiO₂)₂₀ (mole %), the second protective layer was deposited on the recording layer to a thickness of 14 nm.

Next, with a sputtering method using a sputtering target of SiC, the third protective layer was deposited on the second protective layer to a thickness of 4 nm.

Next, with a sputtering method using a sputtering target of pure Ag, the reflective layer was deposited on the third protective layer to a thickness of 140 nm.

Next, acrylic curable resin was applied onto the reflective layer by use of a spinner to a thickness of 5 μm to 10 μm, and was irradiated with UV to form a resin protective layer.

Finally, a polycarbonate resin substrate of 12 cm in diameter and 0.6 mm in thickness was bonded to the resin protective layer by use of an adhesive. In this way the optical recording medium of Example 1 was prepared.

### EXAMPLE 2

—Preparation of Optical Recording Medium—

An optical recording medium of Example 2 was prepared in a manner similar to that described in Example 1 except that the composition of the recording layer was changed to Ge₁₆Sb₇₉Ag₅.

### EXAMPLE 3

—Preparation of Optical Recording Medium—

An optical recording medium of Example 3 was prepared in a manner similar to that described in Example 1 except that the composition of the recording layer was changed to In₁₃Sb₈₂Ag₅.

### EXAMPLE 4

—Preparation of Optical Recording Medium—

An optical recording medium of Example 4 was prepared in a manner similar to that described in Example 1 except that the composition of the recording layer was changed to Ga₉Ge₃Sb₈₅Ag₃.

### EXAMPLE 5

—Preparation of Optical Recording Medium—

An optical recording medium of Example 5 was prepared in a manner similar to that described in Example 1 except that the composition of the recording layer was changed to Ga₈In₄Sb₈₃Ag₅.

### EXAMPLE 6

—Preparation of Optical Recording Medium—

An optical recording medium of Example 6 was prepared in a manner similar to that described in Example 1 except that the composition of the recording layer was changed to Ga₉Sb₈₁Ag₅Te₅.

### EXAMPLE 7

—Preparation of Optical Recording Medium—

An optical recording medium of Example 7 was prepared in a manner similar to that described in Example 1 except that the composition of the recording layer was changed to Ga₁₁Sb₈₄Ag₂Mn₃.

### COMPARATIVE EXAMPLE 1

—Preparation of Optical Recording Medium—

An optical recording medium of Comparative Example 1 was prepared in a manner similar to that described in Example 1 except that the composition of the recording layer was changed to Ga₁₀Sb₉₀.

<Initialization>

Initialization was performed in the following procedure: Using PCR DISK INITIALIZER, an initializer manufactured by Hitachi Computer Peripherals Co., Ltd., each optical recording medium was rotated at a constant linear velocity and a laser beam with a power density of 10 mW/μm² to 30 mW/μm² was applied onto the optical recording medium while moving the laser beam at a constant speed in the radial direction of the optical recording medium.

<Evaluations>

The initialized optical recording media were evaluated for their reflectivity distribution and recording characteristics in the procedure described below. The results are shown in Tables 1 to 3.

—Reflectivity Distribution—

Evaluation of reflectivity distribution was made by determining the reflectivity uniformity of reflectivity signals obtained from the optical recording medium, i.e., (maximum reflectivity value−minimum reflectivity value)/average of reflectivity values). Meanwhile, evaluation of recording characteristics was made in the following procedure: Using DDU-1000, an optical disk evaluation device manufactured by Pulstec Industrial Co., Ltd., which is equipped with an optical pickup (NA=0.65, wavelength=660 nm), the C/N ratio was measured after 10 times 3T single pattern overwriting with EFM+modulation at a recording linear velocity of 28 m/s (equivalent to 8×DVD recording speed) and at a linear density of 0.267 μm/bit. The evaluation criteria are described below.

—Evaluation of Reflectivity Distribution—

Evaluation of reflectivity distribution was made based on the criteria listed below with reference to the reflectivity of an initialized DVD+RW disc supporting 2.4× recording, which is commercially available (shown in Table 6 as a reference)

“A” . . . reflective uniformity is 0.05 or less is,

“B” . . . reflective uniformity is greater than 0.05 but 0.10 or less

“C” . . . reflective uniformity is greater than 0.10

In Comparative Example 1 the initialized recording layer was observed with a transmission electron microscope (TEM), determining the difference in the crystal conditions (see FIG. 7).

—Evaluation of Recording Characteristics—

It is reported that the C/N ratio needs to be at least 45 dB or greater in order to achieve rewritable optical disc systems, and that more stable systems can be achieved if the C/N ratio is 50 dB or greater. In view of this fact, evaluation of recording characteristics was made based on the criteria listed below.

“A” . . . C/N ratio is 50 dB or greater

“B” . . . C/N ratio is 45 dB or greater but less than 50 dB

“C” . . . C/N ratio is less than 45 dB

TABLE 1

| | | Example 1 | Example 2 | Example 3 |
|---|---|---|---|---|
| Layer structure | Reflective layer | Ag | Ag | Ag |
| | Third protective | SiC | SiC | SiC |
| | layer | | | |
| | Second protective | ZnS—SiO₂ | ZnS—SiO₂ | ZnS—SiO₂ |
| | layer | | | |
| | Recording layer | Ga₉Sb₈₆Ag₅ | Ge₁₆Sb₇₉Ag₅ | In₁₃Sb₈₂Ag₅ |
| | First protective | ZnS—SiO₂ | ZnS—SiO₂ | ZnS—SiO₂ |
| | layer | | | |
| | Substrate | Polycarbonate | Polycarbonate | Polycarbonate |
| Evaluation results | Signal pattern | [symbol] | [symbol] | [symbol] |
| | Recording | A | A | A |
| | characteristics | | | |
| | Reflectivity | A | A | B |
| | uniformity | | | |

TABLE 2

| | | Example 4 | Example 5 | Example 6 |
|---|---|---|---|---|
| Layer structure | Reflective layer | Ag | Ag | Ag |
| | Third protective | SiC | SiC | SiC |
| | layer | | | |
| | Second protective | ZnS—SiO₂ | ZnS—SiO₂ | ZnS—SiO₂ |
| | layer | | | |
| | Recording layer | Ga₉Ge₃Sb₈₅Ag₃ | Ga₈In₄Sb₈₃Ag₅ | Ga₉Sb₈₁Ag₅Te₅ |
| | First protective | ZnS—SiO₂ | ZnS—SiO₂ | ZnS—SiO₂ |
| | layer | | | |
| | Substrate | Polycarbonate | Polycarbonate | Polycarbonate |
| Evaluation results | Signal pattern | [symbol] | [symbol] | [symbol] |
| | Recording | B | B | B |
| | characteristics | | | |
| | Reflectivity | A | A | B |
| | uniformity | | | |

TABLE 3

| | | | Comparative |
|---|---|---|---|
| | | Example 7 | Example 1 |
| Layer | Metallic reflective layer | Ag | Ag |
| structure | | | |
| | Third protective layer | SiC | SiC |
| | Second protective layer | ZnS—SiO₂ | ZnS—SiO₂ |
| | Recording layer | Ga₁₁Sb₈₄Ag₂Mn₃ | Ga₁₀Sb₉₀ |
| | First protective layer | ZnS—SiO₂ | ZnS—SiO₂ |
| | Substrate | Polycarbonate | Polycarbonate |
| Evaluation | Signal pattern | [symbol] | [symbol] |
| results | | | |
| | Recording characteristics | B | C |
| | Reflectivity uniformity | B | C |

The results shown in Tables 1 to 3 indicate that in Examples 1 to 7 the reflectivity distributions after initialization are all small and, with respect to their recording characteristics, the C/N ratios are all greater than 45 dB. By contrast, in Comparative Example 1 where the recording layer contains no Ag, the reflectivity distribution is remarkably broad compared to those in Examples 1 to 7, leading to a conclusion that the reflectivity uniformity is poor and the recording layer is not uniformly initialized. In Comparative Example 1, excellent recording characteristics were not obtained, due to large fluctuations of the reflectivity signal.

FIG. 7 showing the state of the initialized recording layer in Comparative Example 1 (observed with a transmission electron microscope) reveals the non-uniform presence of small-diameter crystal particles and large-diameter crystal particles (which are not usually observed), which leads to a broad reflectivity distribution.

### EXAMPLE 8

—Preparation of Optical Recording Medium—

With a sputtering method (using Big Sprinter, a sputtering device manufactured by Unaxis, Co. Ltd.), a first protective layer, recording layer, second protective layer, third protective layer, and reflective layer were sequentially deposited on a substrate.

At first, a polycarbonate resin substrate of 12 cm in diameter and 0.6 mm in thickness having a pattern of wobble grooves with constant track pitch of 0.74 μm was prepared.

Next, with a sputtering method using a sputtering target of (ZnS)₈₀(SiO₂)₂₀ (mole %), the first protective layer was deposited on the substrate to a thickness of 65 nm.

Next, with a sputtering method using a sputtering target of Ga₁₁Sb₇₂Ag₂Sn₁₅ (atomic %), the recording layer was deposited on the first protective layer to a thickness of 16 nm. Here, sputtering was performed under the following conditions: Ar gas pressure=3.0×10⁻³ Torr; and DC power=1.0 kW. Note that the target of the recording layer was rendered disc shape by measuring a predetermined amount of sputtering target into a glass ample, heating it to melt, pulverizing the resultant sputtering target with a pulverizer, and heating and baking the resultant power. The elemental ratio of the deposited recording layer analyzed by inductively coupled plasma (ICP) emission spectrophotometric analysis was determined to be identical to that of the sputtering target measured into the glass ample. A sequential ICP emission spectrophotometric analyzer (SPS4000, manufactured by Seiko Instruments, Inc.) was used for this analysis. It should be noted also in Examples and Comparative Example to be described later that the alloy composition of the recording layer is identical to that of the sputtering target.

Next, with a sputtering method using a sputtering target of (ZnS)₈₀(SiO₂)₂₀ (mole %), the second protective layer was deposited on the recording layer to a thickness of 10 nm.

Next, with a sputtering method using a sputtering target of SiC, the third protective layer was deposited on the second protective layer to a thickness of 4 nm.

Next, with a sputtering method using a sputtering target of pure Ag, the reflective layer was deposited on the third protective layer to a thickness of 140 nm.

Next, acrylic curable resin (produced by Dainippon Ink and Chemicals, Incorporated) was applied onto the reflective layer by use of a spinner to a thickness of 5 μm to 10 μm, and was irradiated with UV to form a resin protective layer.

Finally, a polycarbonate resin substrate of 12 cm in diameter and 0.6 mm in thickness was bonded to the resin protective layer by use of an adhesive. In this way the optical recording medium of Example 8 was prepared.

### EXAMPLE 9

—Preparation of Optical Recording Medium—

An optical recording medium of Example 9 was prepared in a manner similar to that described in Example 8 except that the composition of the recording layer was changed to Ga₁₃Sb₇₀Ag₂Sn₁₅.

### EXAMPLE 10

—Preparation of Optical Recording Medium—

An optical recording medium of Example 10 was prepared in a manner similar to that described in Example 8 except that the composition of the recording layer was changed to Ga₄Ge₇Sb₆₉Ag₃₅n₁₇.

### EXAMPLE 11

—Preparation of Optical Recording Medium—

An optical recording medium of Example 11 was prepared in a manner similar to that described in Example 8 except that the composition of the recording layer was changed to Ga₄Ge₉Sb₆₄Ag₃Sn₂₀.

### EXAMPLE 12

—Preparation of Optical Recording Medium—

An optical recording medium of Example 12 was prepared in a manner similar to that described in Example 8 except that the composition of the recording layer was changed to Ga₁₀In₂Sb₇₀Ag₃Sn₁₅.

### EXAMPLE 13

—Preparation of Optical Recording Medium—

An optical recording medium of Example 13 was prepared in a manner similar to that described in Example 8 except that the composition of the recording layer was changed to Ge₁₂Sb₆₇Ag₃Sn₁₈.

### EXAMPLE 14

—Preparation of Optical Recording Medium—

An optical recording medium of Example 14 was prepared in a manner similar to that described in Example 8 except that the composition of the recording layer was changed to In₁₈Sb₇₀Ag₃Sn₄Te₅.

### EXAMPLE 15

—Preparation of Optical Recording Medium—

An optical recording medium of Example 15 was prepared in a manner similar to that described in Example 8 except that the composition of the recording layer was changed to Ga₄Ge₈Sb₆₈Ag₂Sn₁₅Mn₃.

### COMPARATIVE EXAMPLE 2

—Preparation of Optical Recording Medium—

An optical recording medium of Comparative Example 2 was prepared in a manner similar to that described in Example 8 except that the composition of the recording layer was changed to Sb₈₅Sn₁₀Ag₅.

The optical recording media (optical discs) prepared in Examples 8 to 15 and Comparative Example 2 were initialized and evaluated for their recording characteristics and storage reliability.

<Initialization>

Initialization was performed in the following procedure: Using PCR DISK INITIALIZER, an initializer manufactured by Hitachi Computer Peripherals Co., Ltd., each optical disc was rotated at a constant linear velocity and a laser beam with a power density of 10 mW/μm² to 30 mW/μm² was applied onto the optical disc while moving the laser beam at a constant speed in the radial direction of the optical disc.

<Evaluation of Recording Characteristics>

Evaluation of recording characteristics was made in the following procedure: Using DDU-1000, an optical disk evaluation device manufactured by Pulstec Industrial Co., Ltd., which is equipped with an optical pickup (NA=0.65, wavelength=660 nm), the C/N ratio was measured after 10 times 3T single pattern overwriting with EFM+modulation at a recording linear velocity of 28 m/s (equivalent to 8×DVD recording speed) and at a linear density of 0.267 μm/bit. The obtained C/N ratios were evaluated based on the criteria listed below. The evaluation results are shown in Tables 4-1 to 6.

Note that the C/N ratio needs to be at least 45 dB or greater in order to achieve rewritable optical disc systems, and that more stable systems can be achieved if the C/N ratio is 50 dB or greater.

—Evaluation Criteria—

“C” . . . C/N ratio is less than 45 dB

“B” . . . C/N ratio is 45 dB or greater but less than 50 dB

“A” . . . C/N ratio is 50 dB or greater

<Crystallization Rate>

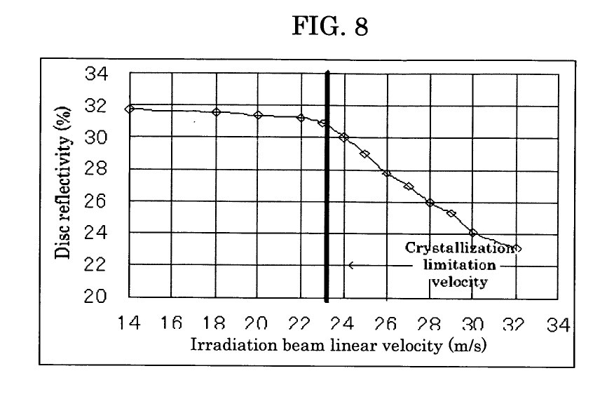

The crystallization limitation velocity described above represents the characteristics of recording material, and means the light beam linear velocity at which optical disc reflectivity shows a rapid decrease as shown in FIG. 8, when a DC beam of constant power is applied onto a rotating optical disc to evaluate the dependency of optical disc reflectivity on light beam (note: recording or reproduction beam) linear velocity, or rotational speed of the optical disc. The evaluation method employing this crystallization limitation velocity focuses on the limit of linear velocity, beyond which crystallization (or information-erasing) is impossible, when a recording or reproduction beam linear velocity is continuously increased while regarding the “DC beam of constant power” as a laser pulse (erasing pulse) of intermediate output level described in the foregoing recording principle. In FIG. 8, even when a DC beam is applied onto an optical disc at a high linear velocity beyond the crystallization limitation velocity of the recording material (donated by a heavy line in this drawing), for example, it results in poor crystallization performance. The evaluation results are shown in Tables 4-1 to 6

—Evaluation Criteria—

“B” . . . crystallization limitation veloctiy of optical disc (see FIG. 8) is 20 m/s or greater

“C” . . . crystallization limitation velocity of optical disc (see FIG. 8) is less than 20 m/s

<Recording Sensitivity>

The evaluation criteria of recording sensitivity are as follows:

“B” . . . optimal laser power required to record patterns is less than 40 mW

“C” . . . optimal laser power required to record patterns is 40 mW or greater

The evaluation results are shown in Tables 4-1 to 6.

<Reflectivity After Initialization>

The reflectivity of the initialized non-recorded portions to recording and reproduction laser beams (wavelength=660 nm) was measured with the foregoing optical disk evaluation device under the following condition: reproduction rate=3.5 m/s; read power=0.7 mW. The evaluation results are shown in Tables 4-1 to 6. It should be noted that the reflectivity of the initialized non-recorded portions to recording and reproduction laser beams (wavelength=660 nm) is preferably 18% or more, more preferably 20% or more. If the reflectivity is less than 18%, reproduction and recording of signals may become difficult.

—Evaluation Criteria—

“B” . . . reflectivity is 18% or more

“C” . . . reflectivity is less than 18%

<Reflectivity Uniformity>

The reflectivity of the initialized non-recorded portions to recording and reproduction laser beams (wavelength=660 nm, NA=0.65) was measured with the foregoing optical disk evaluation device under the following condition: reproduction rate=3.5 m/s; read power=0.7 mW. The evaluation results are shown in Tables 4-1 to 6.

—Evaluation Criteria—

Evaluation of reflectivity distribution was made based on the criteria described below with reference to the reflectivity of an initialized DVD+RW disc supporting 2.4× recording, which is commercially available (shown in Table 6 as a reference).

“A” . . . reflective uniformity is 0.05 or less is,

“B” . . . reflective uniformity is greater than 0.05 but 0.10 or less

“C” . . . reflective uniformity is greater than 0.10

<Evaluation of Storage Reliability>

The optical discs prepared in Examples 8 to 15 and Comparative Example 2 were placed into a constant-temperature bath (80° C., 85% RH) for 300 hours. After this, their C/N ratios were determined to evaluate the storage reliability based on the criteria listed below. The evaluation results are shown in Tables 4-1 to 6.

<Evaluation Criteria>

“A” . . . C/N ratio after placed in a constant-temperature bath (80° C., 85% RH) for 300 hours is 50 dB or greater

“B” . . . C/N ratio after placed in a constant-temperature bath (80° C., 85% RH) for 300 hours is 45 dB or greater but less than 50 dB

“C” . . . C/N ratio after placed in a constant-temperature bath (80° C., 85% RH) for 300 hours is less than 45 dB

Note that a symbol “-” is provided for non-evaluated items.

TABLE 4-1

| | Example | Example 8 | Example 9 |
|---|---|---|---|
| | Recording material | Ga₁₁Sb₇₂Ag₂Sn₁₅ | Ga₁₃Sb₇₀Ag₂Sn₁₅ |
| Evaluation | Recording | A | A |
| results | characteristics | | |
| | Crystallization rate | B | B |
| | Recording sensitivity | B | B |
| | Reflectivity after | B | B |
| | initialization | | |
| | Reflectivity uniformity | A | B |
| | Storage reliability | B | B |
| | Signal pattern | [symbol] | [symbol] |

TABLE 4-2

| | Example | Example 10 | Example 11 |
|---|---|---|---|
| | Recording material | Ga₄Ge₇Sb₆₉Ag₃Sn₁₇ | Ga₄Ge₉Sb₆₄Ag₃Sn₂₀ |
| Evaluation results | Recording | A | A |
| | characteristics | | |
| | Crystallization rate | B | B |
| | Recording sensitivity | B | B |
| | Reflectivity after | B | B |
| | initialization | | |
| | Reflectivity uniformity | A | A |
| | Storage reliability | A | A |
| | Signal pattern | [symbol] | [symbol] |

TABLE 5-1

| | Example | Example 12 | Example 13 |
|---|---|---|---|
| | Recording material | Ga₁₀In₂Sb₇₀Ag₃Sn₁₅ | Ge₁₂Sb₆₇Ag₃Sn₁₈ |
| Evaluation results | Recording | B | B |
| | characteristics | | |
| | Crystallization rate | B | B |
| | Recording sensitivity | B | B |
| | Reflectivity after | B | B |
| | initialization | | |
| | Reflectivity uniformity | A | A |
| | Storage reliability | B | A |
| | Signal pattern | [symbol] | [symbol] |

TABLE 5-2

| | Example | Example 14 | Example 15 |
|---|---|---|---|
| | Recording material | In₁₈Sb₇₀Ag₃Sn₄Te₅ | Ga₄Ge₈Sb₆₈Ag₂Sn₁₅Mn₃ |
| Evaluation results | Recording | B | A |
| | characteristics | | |
| | Crystallization rate | B | B |
| | Recording sensitivity | B | B |
| | Reflectivity after | B | B |
| | initialization | | |
| | Reflectivity uniformity | B | B |
| | Storage reliability | B | B |
| | Signal pattern | [symbol] | [symbol] |

TABLE 6

| | | Comparative | |
|---|---|---|---|
| | Example | Example 2 | Reference Example |
| | Recording material | Sb₈₅Sn₁₀Ag₅ | DVD + RW supporting 2.4x |
| Evaluation results | Recording | C | — |
| | characteristics | | |
| | Crystallization rate | B | — |
| | Recording sensitivity | C | — |
| | Reflectivity after | B | B |
| | initialization | | |
| | Reflectivity uniformity | C | A |
| | Storage reliability | C | |
| | Signal pattern | [symbol] | [symbol] |

The results shown in Tables 4-1, 4-2 and 5-2 indicate that both recording characteristics and storage reliability were excellent in Examples 8 to 15—the C/N ratios were all 45 dB or greater even after a 300-hour endurance test in a constant-temperature bath (80° C., 85% RH). In particular, C/N ratios of as high as 50 dB or greater were achieved in Examples 8 to 11 and 13, where Ga—Sb recording material or Ga—Ge—Sb recording material was used.

Moreover, Examples 10, 11 and 13, where a recording layer containing Ge was used, offered no reduction in the recording characteristics even after a 300-hour endurance test in a constant-temperature bath (80° C., 85% RH). Examples 11 and 12, where a recording layer containing In was used, offered small C/N ratios compared to that in Example 8 because In does not increase the crystallization rate too much, as does Ga. In spite of this, Examples 11 and 12 offered CN ratios as high as 45 dB or greater, with the expectation that excellent recording characteristics would be provided. In addition, Example 14 offered excellent storage reliability by virtue of the presence of Te, though the recording layer in this Example does not contain Ge and has a high Sb ratio.

Since the recording layer in Comparative Example 2 does not contain at least one element selected from Ga, Ge and In, it resulted in poor recording characteristics and storage reliability, though the crystallization rate and reflectivity uniformity after initialization were excellent.

The optical recording medium of the present invention can be suitably used for various optical recording media such as CD-R, CD-RW and DVD—particularly for high-speed optical recording media supporting 3× to 10×DVD recording speeds, particularly 8× or faster. Moreover, the optical recording medium of the present invention can also be applied to various rewritable (phase-change) optical recording media ranging from optical recording media using a CAV recording technology to record at a maximum speed of 8×DVD+RW recording to low-compatible optical recording media supporting 3× speed recording.

What is claimed is:

1. An optical recording medium comprising:
a substrate;
a first protective layer;
a recording layer;
a second protective layer; and
a reflective layer,
the first protective layer, recording layer, second protective layer and reflective layer being disposed on the substrate in this order or in reverse order,
wherein the recording layer comprises a composition expressed by the following Formula 1:
(X₁)_{α}Sb_{β}(X₂)_{γ} <Formula 1>
where X₁ represents at least one element selected from Ga, Ge and In; X₂ represents at least one element selected from Au, Ag and Cu; and α, β and γ represent atomic % of their respective elements (where 2≦α≦20, 55≦β≦95, 0<γ≦10, and (α+β+γ)=100).

2. The optical recording medium according to claim 1, wherein the recording layer is expressed by the formula Ga_{α}Ge_{β}In_{γ}—Sb_{δ}—(X₂)_{ε}Sn_{ζ}—Y_{η}
where X₂ represents at least one element selected from Au, Ag and Cu; Y represents at least one element selected from Te, Al, Zn, Mg, Tl, Pb, Bi, Cd, Hg, Se, C, N, Mn and Dy; and α, β, γ, δ, ε, ζ and η satisfy the following conditions: 0≦α≦20, 0≦β≦20, 0≦γ≦20 (provided α, β and γ are not “0” at the same time), 40≦δ≦95, 0<ε≦10, 0≦ζ≦40, 0≦η≦10 and (α+β+γ+δ+ε+ζ+η)=100).

3. The optical recording medium according to claim 1, wherein the recording layer performs at least one of a recording operation, an erasing operation and a rewriting operating by utilizing reversible phase change between amorphous and crystalline phases.

4. The optical recording medium according to claim 1, wherein the thickness of the recording layer is 6 nm to 20 nm.

5. The optical recording medium according to claim 1, wherein the first protective layer and the second protective layer comprise a mixture of ZnS and SiO₂.

6. The optical recording medium according to claim 1, wherein the reflective layer comprises one of Ag and an Ag alloy.

7. The optical recording medium according to claim 1, wherein a sulfur-free third protective layer is provided between the second protective layer and the reflective layer, and the sulfur-free third protective layer comprises at least one of SiC and Si.

8. The optical recording medium according to claim 1, wherein an oxide-containing interface layer is provided at least between the recording layer and the first protective layer or between the recording layer and the second protective layer.

9. The optical recording medium according to claim 1, wherein the reflectivity uniformity, expressed by the following Expression 1, of an initialized non-recorded portion to a recording and reproduction laser beam is 0.10 or less.
Reflectivity uniformity=(maximum reflectivity value−minimum reflectivity value)/average of reflectivity values. <Expression 1>

10. The optical recording medium according to claim 1, wherein the substrate comprises a wobble groove of 0.74±0.03 μm in pitch, 22 nm to 40 nm in depth, and 0.2 μm to 0.4 μm in width.

11. The optical recording medium according to claim 1, capable of recording at 3× to 10×DVD recording speeds.

12. An optical recording medium comprising:
a substrate;
a first protective layer;
a recording layer;
a second protective layer; and
a reflective layer,
the first protective layer, recording layer, second protective layer and reflective layer being disposed on the substrate in this order or in reverse order,
wherein the recording layer comprises a composition expressed by the following Formula 2:
(X₁)_{α}Sb_{β}(X₂)_{γ}-M_{δ} <Formula 2>
where X₁ represents at least one element selected from Ga, Ge and In; X₂ represents at least one element selected from Au, Ag and Cu; M represents at least one element selected from elements other than X₁, Sb and X₂ and mixtures of the elements other than X₁, Sb and X₂; and α, β, γ and δ represent atomic % of their respective elements (where 2≦α≦20, 55≦β≦95, 0<γ≦10, 0<δ≦40, and (α+β+γ+δ)=100).

13. The optical recording medium according to claim 12, wherein M represents at least one element selected from Te, Al, Zn, Mg, Tl, Pb, Sn, Bi, Cd, Hg, Se, C, N, Mn and Dy.

14. The optical recording medium according to claim 12, wherein the recording layer comprises a composition expressed by the following Formula 3:
(X₁)_{α}Sb_{β}(X₂)_{γ}—Sn_{δ} <Formula 3>
where X₁ represents at least one element selected from Ga, Ge and In; X₂ represents at least one element selected from Au, Ag and Cu; and α, β, γ and δ represent atomic % of their respective elements (where 2≦α≦20, 55≦β≦95, 0<γ≦10, 0<δ≦40, and (α+β+γ+δ)=100).

15. The optical recording medium according to claim 12, wherein the recording layer is expressed by the formula Ga_{α}Ge_{β}In_{γ}—Sb_{δ}—(X₂)_{ε}Sn_{ζ}—Y_{η}
where X₂ represents at least one element selected from Au, Ag and Cu; Y represents at least one element selected from Te, Al, Zn, Mg, Tl, Pb, Bi, Cd, Hg, Se, C, N, Mn and Dy; and α, β, γ, δ, ε, ζ and η satisfy the following conditions: 0≦α≦20, 0≦β≦20, 0≦γ≦20 (provided α, β and γ are not “0” at the same time), 40≦δ≦95, 0<ε≦10, 0≦ζ≦40, 0≦η≦10 and (α+β+γ+Γ+ε+ζ+η)=100).

16. The optical recording medium according to claim 12, wherein the recording layer performs at least one of a recording operation, an erasing operation and a rewriting operating by utilizing reversible phase change between amorphous and crystalline phases.

17. The optical recording medium according to claim 12, wherein the thickness of the recording layer is 6 nm to 20 nm.

18. The optical recording medium according to claim 12, wherein the first protective layer and the second protective layer comprise a mixture of ZnS and SiO₂.

19. The optical recording medium according to claim 12, wherein the reflective layer comprises one of Ag and an Ag alloy.

20. The optical recording medium according to claim 12, wherein a sulfur-free third protective layer is provided between the second protective layer and the reflective layer, and the sulfur-free third protective layer comprises at least one of SiC and Si.

21. The optical recording medium according to claim 12, wherein an oxide-containing interface layer is provided at least between the recording layer and the first protective layer or between the recording layer and the second protective layer.

22. The optical recording medium according to claim 12, wherein the reflectivity uniformity, expressed by the following Expression 1, of an initialized non-recorded portion to a recording and reproduction laser beam is 0.10 or less.
Reflectivity uniformity=(maximum reflectivity value−minimum reflectivity value)/average of reflectivity values. <Expression 1>

23. The optical recording medium according to claim 12, wherein the substrate comprises a wobble groove of 0.74±0.03 μm in pitch, 22 nm to 40 nm in depth, and 0.2 μm to 0.4 μm in width.

24. The optical recording medium according to claim 12, capable of recording at 3× to 10×DVD recording speeds.

25. A sputtering target used for the production of a recording layer, the sputtering target comprising:
a composition expressed by the following Formula 1:
(X₁)_{α}Sb_{β}(X₂)_{γ} <Formula 1>
where X₁ represents at least one element selected from Ga, Ge and In; X₂ represents at least one element selected from Au, Ag and Cu; and α, β and γ represent atomic % of their respective elements (where 2≦α≦20, 55≦β≦95, 0<γ≦10, and (α+β+γ)=100).

26. The sputtering target according to claim 25, expressed by the formula Ga_{α}Ge_{β}In_{γ}—Sb_{δ}—(X₂)_{ε}Sn_{ζ}—Y_{η}
where X₂ represents at least one element selected from Au, Ag and Cu; Y represents at least one element selected from Te, Al, Zn, Mg, Tl, Pb, Bi, Cd, Hg, Se, C, N, Mn and Dy; and α, β, γ, δ, ε, ζ and η satisfy the following conditions: 0≦α≦20, 0≦β≦20, 0≦γ≦20 (provided α, β and γ are not “0” at the same time), 40≦δ≦95, 0<ε≦10, 0≦ζ≦40, 0≦η≦10 and (α+β+γ+δ+ε+ζ+η)=100).

27. A sputtering target used for the production of a recording layer, the sputtering target comprising:
a composition expressed by the following Formula 2:
(X₁)_{α}Sb_{β}(X₂)_{γ}-M_{δ} [Formula 2]
where X₁ represents at least one element selected from Ga, Ge and In; X₂ represents at least one element selected from Au, Ag and Cu; M represents at least one element selected from elements other than X₁, Sb and X₂ and mixtures of the elements other than X₁, Sb and X₂; and α, β, γ and δ represent atomic % of their respective elements (where 2≦α≦20, 55≦β≦95, 0<γ≦10, 0<δ≦40, and (α+β+γ+δ)=100).

28. The sputtering target according to claim 27, wherein M represents at least one element selected from Te, Al, Zn, Mg, Tl, Pb, Sn, Bi, Cd, Hg, Se, C, N, Mn and Dy.

29. The sputtering target according to claim 27, comprising a composition expressed by the following Formula 3:
(X₁)_{α}Sb_{β}(X₂)_{γ}—Sn_{δ} [Formula 3]
where X₁ represents at least one element selected from Ga, Ge and In; X₂ represents at least one element selected from Au, Ag and Cu; and α, β, γ and δ represent atomic % of their respective elements (where 2≦α≦20, 55≦β≦95, 0<γ≦10, 0<δ≦40, and (α+β+γ+δ)=100).

30. The sputtering target according to claim 27, expressed by the formula Ga_{α}Ge_{β}In_{γ}—Sb_{δ}—(X₂)_{ε}Sn_{ζ}—Y_{η}
where X₂ represents at least one element selected from Au, Ag and Cu; Y represents at least one element selected from Te, Al, Zn, Mg, Tl, Pb, Bi, Cd, Hg, Se, C, N, Mn and Dy; and α, β, γ, δ, ε, ζ and η satisfy the following conditions: 0≦α≦20, 0≦β≦20, 0≦γ≦20 (provided α, β and γ are not “0” at the same time), 40≦δ≦95, 0<ε≦10, 0≦ζ≦40, 0≦η≦10 and (α+β+γ+δ+ε+ζ+η)=100).

31. A method for manufacturing an optical recording medium, comprising:
forming a recording layer with a sputtering method using a sputtering target,
wherein the sputtering target comprises a composition expressed by the following Formula 1:
(X₁)_{α}Sb_{β}(X₂)_{γ} <Formula 1>
where X₁ represents at least one element selected from Ga, Ge and In; X₂ represents at least one element selected from Au, Ag and Cu; and α, β and γ represent atomic % of their respective elements (where 2≦α≦20, 55≦β≦95, 0<γ≦10, and (α+β+γ)=100), and
wherein the optical recording medium comprises:
a substrate;
a first protective layer;
the recording layer;
a second protective layer; and
a reflective layer,
the first protective layer, recording layer, second protective layer and reflective layer being disposed on the substrate in this order or in reverse order.

32. A method for manufacturing an optical recording medium, comprising:
forming a recording layer with a sputtering method using a sputtering target,
wherein the sputtering target comprises a composition expressed by the following Formula 2:
(X₁)_{α}Sb_{β}(X₂)_{γ}-M_{δ} [Formula 2]
where X₁ represents at least one element selected from Ga, Ge and In; X₂ represents at least one element selected from Au, Ag and Cu; M represents at least one element selected from elements other than X₁, Sb and X₂ and mixtures of the elements other than X₁, Sb and X₂; and α, β, γ and δ represent atomic % of their respective elements (where 2≦α≦20, 55≦β≦95, 0<γ≦10, 0<δ≦40, and (α+β+γ+δ)=100), and
wherein the optical recording medium comprises:
a substrate;
a first protective layer;
the recording layer;
a second protective layer; and
a reflective layer,
the first protective layer, recording layer, second protective layer and reflective layer being disposed on the substrate in this order or in reverse order.

33. A method for using an optical recording medium, comprising:
applying a laser beam onto an optical recording medium from the first protective layer side to perform at least one of a recording operation, an erasing operation and a rewriting operation,
wherein the optical recording medium comprises:
a substrate;
a first protective layer;
a recording layer;
a second protective layer; and
a reflective layer,
the first protective layer, recording layer, second protective layer and reflective layer being disposed on the substrate in this order or in reverse order,
wherein the recording layer comprises a composition expressed by the following Formula 1:
(X₁)_{α}Sb_{β}(X₂)_{γ} <Formula 1>
where X₁ represents at least one element selected from Ga, Ge and In; X₂ represents at least one element selected from Au, Ag and Cu; and α, β and γ represent atomic % of their respective elements (where 2≦α≦20, 55≦β≦95, 0<γ≦10, and (α+β+γ)=100).

34. A method for using an optical recording medium, comprising:
applying a laser beam onto an optical recording medium from the first protective layer side to perform at least one of a recording operation, an erasing operation and a rewriting operation,
wherein the optical recording medium comprises:
a substrate;
a first protective layer;
a recording layer;
a second protective layer; and
a reflective layer,
the first protective layer, recording layer, second protective layer and reflective layer being disposed on the substrate in this order or in reverse order,
wherein the recording layer comprises a composition expressed by the following Formula 2:
(X₁)_{α}Sb_{β}(X₂)_{γ}-M_{δ} <Formula 2>
where X₁ represents at least one element selected from Ga, Ge and In; X₂ represents at least one element selected from Au, Ag and Cu; M represents at least one element selected from elements other than X₁, Sb and X₂ and mixtures of the elements other than X₁, Sb and X₂; and α, β, γ and δ represent atomic % of their respective elements (where 2≦α≦20, 55≦β≦95, 0<γ≦10, 0<δ≦40, and (α+β+γ+δ)=100).

35. An optical recording apparatus for applying a laser beam onto an optical recording medium from a laser beam source to thereby perform at least one of a recording operation, an erasing operation and a rewriting operation on the optical recording medium,
wherein the optical recording medium comprises:
a substrate;
a first protective layer;
a recording layer;
a second protective layer; and
a reflective layer,
the first protective layer, recording layer, second protective layer and reflective layer being disposed on the substrate in this order or in reverse order,
wherein the recording layer comprises a composition expressed by the following Formula 1:
(X₁)_{α}Sb_{β}(X₂)_{γ} <Formula 1>
where X₁ represents at least one element selected from Ga, Ge and In; X₂ represents at least one element selected from A, Ag and Cu; and α, β and γ represent atomic % of their respective elements (where 2≦α≦20, 55≦β≦95, 0<γ≦10, and (α+β+γ)=100).

36. An optical recording apparatus for applying a laser beam onto an optical recording medium from a laser beam source to thereby perform at least one of a recording operation, an erasing operation and a rewriting operation on the optical recording medium,
wherein the optical recording medium comprises:
a substrate;
a first protective layer;
a recording layer;
a second protective layer; and
a reflective layer,
the first protective layer, recording layer, second protective layer and reflective layer being disposed on the substrate in this order or in reverse order,
wherein the recording layer comprises a composition expressed by the following Formula 2:
(X₁)_{α}Sb_{β}(X₂)_{γ}-M_{δ} <Formula 2>
where X₁ represents at least one element selected from Ga, Ge and In; X₂ represents at least one element selected from Au, Ag and Cu; M represents at least one element selected from elements other than X₁, Sb and X₂ and mixtures of the elements other than X₁, Sb and X₂; and α, β, γ and δ represent atomic % of their respective elements (where 2≦α≦20, 55≦β≦95, 0<γ≦10, 0<δ≦40, and (α+β+γ+δ)=100).
